(19) United States
(12) Patent Application Publication
(10) Pub. No.: US 2020/0197928 A1
(43) Pub. Date: Jun. 25, 2020

(54) ADAPTABLE DETECTION APPARATUS

(71) Applicants: Nicolas LETOURNEAU, Raleigh, NC (US); Aly KHALIFA, Raleigh, NC (US); UNDERCOVER COLORS, INC., RALEIGH, NC (US)

(72) Inventors: NICOLAS LETOURNEAU, RALEIGH, NC (US); ALY KHALIFA, RALEIGH, NC (US); ADAM SANDT, APEX, NC (US); JOSHUA STEVEN JOSEPH, CARY, NC (US)

(21) Appl. No.: 16/612,559

(22) PCT Filed: May 11, 2018
(86) PCT No.: PCT/US18/32462

§ 371 Date: Nov. 11, 2019

Related U.S. Application Data
(60) Provisional application No. 62/505,576, filed on May 12, 2017.
(60) Provisional application No. 62/505,588, filed on May 12, 2017.

(51) Int. Cl. B01L 3/00

(52) U.S. Cl. CPC B01L 3/5023; B01L 2400/086; B01L 2300/0663; B01L 2200/12; B01L 2300/025; B01L 2300/12; B01L 2300/0832; B01L 2200/0684

(57) ABSTRACT

Described herein are an adaptable apparatus and methods for detecting the presence of a target substance in a liquid. For example, the adaptable apparatus can be a medallion that detects illicit drugs in a beverage. The adaptable apparatus comprises a detection unit comprising an indicator that is configured to display a signal upon the detection of an interaction with the target substance. In some examples, the adaptable apparatus can be attached to an implement.

### CROSS-REFERENCES TO RELATED APPLICATIONS

This application claims priority to U.S. Provisional Application No. 62/287,623, filed on Jan. 27, 2016; U.S. Provisional Application No. 62/287,677, filed on Jan. 27, 2016; U.S. Provisional Application No. 62/287,643, filed on Jan. 27, 2016; U.S. Provisional Application No. 62/337,603, filed on May 17, 2016; Jan. 27, 2016; U.S. Provisional Application No. 62/337,558, filed on May 17, 2016; U.S. Provisional Application No. 62/337,608, filed on May 17, 2016; PCT/US17/15504, filed Jan. 27, 2017; PCT/US17/15489, filed Jan. 27, 2017; PCT/US17/15500, filed on Jan. 27, 2017; U.S. application Ser. No. 15/449,701, filed Mar. 3, 2017; and U.S. application Ser. No. 15/449,721, filed Mar. 3, 2017; U.S. Provisional Application No. 62/505,576 filed on May 12, 2017; U.S. Provisional Application No. 62/505,588 filed on May 12, 2017; each of which is incorporated herein by reference in its entirety.

### FIELD

Described herein are apparatus and methods for detecting a target substance. For example, the apparatus and methods described herein can be used for real-time detection of illicit drugs, different compounds in liquids, and/or different compounds in solids.

### BACKGROUND

The demand and need for persons to be able detect different substances on a real-time basis has increased as the prevalence of auto-immune disorders and different allergies diagnoses have increased. This increase has also corresponded with an increased frequency of drug use and abuse. In view of these trends, conventional testing methods and devices often are too cumbersome or take too long to evaluate a particular medium for a target substance. In some cases, no specific apparatus for real-time detection for certain target substances or compounds exist.

For example, an increased misuse of various psychotropic and/or sedating drugs for recreational or criminal purposes has become more problematic. A particularly troubling form of misuse is the surreptitious introduction of these drugs into ordinary drinks for the purpose of rendering the consumer of the drink disoriented or unconscious. The unknowingly sedated individual may then be taken advantage of, e.g., become the victim of robbery or sexual assault. Drug-facilitated sexual assault has become increasingly common, particularly among younger members of the population, to the degree that most universities have warning and prevention programs and policies in place to prevent drug-facilitated sexual assault. Conventional apparatus to detect such drugs prior to ingestion often are insufficient as they may be too cumbersome to use, take too long to detect the target substance, detect only a limited substance, and lack selectivity and/or are sensitive to many other non-drug compounds.

As another example, an increased frequency of diagnoses of auto-immune disorders or highly sensitive allergies has occurred in the general population. For example, Celiac's disease, peanut allergies, lactose allergies or other conditions triggered by different ingested substances have become more common in the general population. If the particular harmful substance is ingested by persons having these types of conditions occurs, significant and severe consequences for the person may result.

Viable methods and apparatus for the safe, real-time detection of target substances are needed.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Various embodiments of the present invention relate to an adaptable apparatus and methods for making an adaptable apparatus for detecting a target substance in a liquid. Embodiments may comprise features that enhance the opportunity for the apparatus to be convenient and/or available to test a liquid, such as features that allow the apparatus to be attached to a drink container, to an implement commonly associated with or provided with a mixed drink, or attach to a key ring or lanyard, or attach to a personal cellular device or tool such as a bottle opener.

In some embodiments, an adaptable apparatus for detecting the presence of a target substance includes a housing containing a detection unit and an entry port through which a fluid external to the housing can enter the housing and contact the detection unit. The housing may include a cavity for receiving the detection unit and a protective layer disposed over the cavity capable of sealing the detection unit, including limiting the flowrate or volume of fluid that contacts the detection unit. Optionally, the entry port is at least one opening in the protective layer. In some embodiments, the adaptable apparatus further includes a removable layer disposed directly or indirectly over the detection unit such that upon removal of at least a portion of the removable layer, at least a portion of the detection unit is exposed to an external environment. In some embodiments, at least a portion of the removable layer is disposed over an opening in the protective layer, and the opening is an entry port through which a fluid external to the housing can enter the housing and contact the detection unit. In some embodiments, the apparatus also includes a desiccant layer between the removable layer and protective layer. In some cases, the apparatus may be substantially circular in periphery and planar on at least one face. Optionally, the apparatus may be capable of being positioned on or attached to one or more implements. Implements may include, but are not limited to, key rings, cellular devices, or other personal accessories.

In some embodiments, an adaptable apparatus for detecting the presence of a target substance includes a rod containing a detection unit and an entry port through which a fluid external to the rod can enter and contact the detection unit. The rod may include a cavity for receiving the detection unit and a protective layer disposed over the cavity capable of sealing the detection unit, including limiting the flowrate or volume of fluid that contacts the detection unit. Optionally, the entry port is at least one opening in the protective layer. In some embodiments, at least a portion of the removable layer is disposed over an opening in the protective layer, and the opening is an entry port through which a fluid external to the rod can enter the rod and contact the detection unit. In some embodiments, the head may include a passageway so that the head is moveable along the length of the rod. Optionally, the head may be moveable along the length of the rod. In some cases, the rod may be a stirring device.

In some embodiments, an adaptable apparatus for detecting the presence of a target substance includes a housing containing first and second opposing faces separated by a thickness. In some cases, the first and second opposing faces are substantially planar. In some cases, the housing may include a peripheral surface connecting the first and second opposing faces and extending around a periphery of the housing. The housing may include a passageway from a first opening in the peripheral surface through at least a portion of the housing. In some cases, the first opposing face may include a cavity. The apparatus may include a detection unit for receiving a liquid, where the liquid is disposed in the cavity. The detection unit may be capable of displaying an indication that a target substance is present or absent. In some cases, the detection unit may be a lateral flow assay. The apparatus may include an entry port through which a fluid external to the housing can enter the housing and contact the detection unit. The housing may include a cavity for receiving the detection unit and a protective layer disposed over the cavity capable of sealing the detection unit, including limiting the flowrate or volume of fluid that contacts the detection unit. Optionally, the entry port is at least one opening in the protective layer. In some embodiments, the adaptable apparatus further includes a removable layer disposed directly or indirectly over the detection unit such that upon removal of at least a portion of the removable layer, at least a portion of the detection unit is exposed to an external environment. In some embodiments, at least a portion of the removable layer is disposed over an opening in the protective layer, and the opening is an entry port through which a fluid external to the housing can enter the housing and contact the detection unit. In some embodiments, the passageway ends at a second opening in the peripheral surface. In some cases, the periphery of the housing is substantially circular.

In other embodiments, a method of detecting the presence of a target substance in a liquid is described herein. In some embodiments, the method includes providing the adaptable apparatus, exposing a portion of the adaptable apparatus to the liquid, and observing a visual indication to determine presence or absence of the target substance. In some cases, the apparatus may be exposed to the liquid by touching the apparatus with an implement or finger wetted with the liquid.

In other embodiments, a method of making an adaptable apparatus is described herein. In some embodiments, the method of making an apparatus includes providing a detection unit configured to detect the presence of a target substance, coupling the detection unit to a housing, and coupling a protective layer over the detection unit. In some embodiments, the method of making further includes coupling a removable layer to the housing or protective layer.

In some embodiments, an adaptable apparatus for detecting the presence of a target substance in a liquid includes a housing having a detection unit and a cavity, a protective layer having at least one opening that exposes at least a portion of the detection unit and provides a pathway for the liquid to enter the apparatus, where the protective layer is on top of the detection unit, a removable layer configured such that upon removal of the removable layer, at least a portion of the detection unit is exposed to an external environment, where the target substance includes any one of: amine-containing compound, benzodiazepine, narcotic, alcohol, date rape drug, pesticide, steroid, steroid metabolite, bacteria, pathogen, fungus, poison, toxin, explosive, explosive precursor material, metal, protein, and sugars.

The details of one or more embodiments are set forth in the drawings and description below. Other features, objects, and advantages will be apparent from the drawings, the description, and from the claims.

### BRIEF DESCRIPTION OF DRAWINGS

FIGS. 1A, 1B, and 1C show a perspective view of an apparatus and implement according to one embodiment of the present invention.

FIGS. 2A, 2B, and 2C show a top and bottom exploded view of an apparatus and implement according to one embodiment of the present invention.

FIGS. 3A, 3B, and 3C show a top and bottom exploded view of an apparatus and implement according to one embodiment of the present invention.

FIGS. 4A and 4B show a top and bottom exploded view of an apparatus according to one embodiment of the present invention.

FIG. 5 shows a perspective view of an apparatus according to one embodiment of the present invention.

FIGS. 6A and 6B show a perspective view of an apparatus and implement according to one embodiment of the present invention.

FIG. 7 shows a perspective view of an apparatus according to one embodiment of the present invention.

FIG. 8 shows an exploded view of an apparatus according to one embodiment of the present invention.

FIGS. 9A, 9B, and 9C show an exploded view of an apparatus and implement according to one embodiment of the present invention.

FIG. 10 shows an exploded view of an apparatus according to one embodiment of the present invention.

FIGS. 11A and 11B show an exploded view of an apparatus according to one or more embodiments of the present invention.

FIG. 12 shows an exploded view of an apparatus according to one or more embodiments of the present invention.

FIGS. 13A, 13B, 13C, and 13D show various views of an apparatus according to one embodiment of the present invention. FIGS. 13A and 13B show perspective views of the apparatus. FIG. 13C shows a top view of the apparatus. FIG. 13D shows a side view of the apparatus.

FIGS. 14A, 14B, 14C, and 14D show various views of an apparatus and implement according to one embodiment of the present invention. FIG. 14A shows a top view of the apparatus and implement. FIG. 14B shows a bottom view of the apparatus and implement. FIGS. 14C and 14D show perspective views of the apparatus and implement.

FIGS. 15A, 15B, 15C, and 15D show various views of an implement according to one embodiment of the present invention. FIG. 15A shows a top view of the implement. FIG. 15B shows a bottom view of the implement. FIGS. 15C and 15D show perspective views of the implement.

FIGS. 16A, 16B, 16C, and 16D show various views of an apparatus and implement according to one embodiment of the present invention. FIGS. 16A and 16B show perspective views of the apparatus and implement. FIG. 16C shows a top view of the apparatus and implement. FIG. 16D shows a side view of the apparatus and implement.

FIGS. 17A, 17B, and 17C show various views of an implement according to one embodiment of the present invention. FIGS. 17A and 17B show perspective views of the implement. FIG. 17C shows a top view of the implement.

FIGS. 18A, 18B, and 18C show various views of detection unit according to one embodiment of the present invention. FIG. 18A show a perspective view of the detection unit.

FIG. 18B shows a side view of the detection unit. FIG. 18C shows a top view of the detection unit.

FIG. 19 shows the arrangement of buffers in a detection unit according to one embodiment of the present invention.

FIG. 20 shows a top view of a detection unit according to one embodiment of the present invention.

FIG. 21 shows a cross sectional view of the detection unit and the direction of flow of a liquid through the detection unit according to one embodiment of the present invention.

FIG. 22 shows the top view of the detection unit and the direction of flow of a liquid through the detection unit according to one embodiment of the present invention.

FIG. 23 shows an exploded cross-sectional view of the detection unit according to one embodiment of the present invention.

### DETAILED DESCRIPTION

The subject matter of embodiments of the present invention is described herein with specificity to meet statutory requirements, but this description is not necessarily intended to limit the scope of future claims. The subject matter to be claimed may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. The illustrative examples are given to introduce the reader to the general subject matter discussed herein and not intended to limit the scope of the disclosed concepts. The following sections describe various additional embodiments and examples with reference to the drawings in which like numerals indicate like elements and directional description are used to describe illustrative embodiments but, like the illustrative embodiments, should not be used to limit the present invention.

Unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

An adaptable apparatus for detecting the presence of a target substance includes a housing containing a detection unit and an entry port through which a fluid external to the housing can enter the housing and contact the detection unit. The detection unit is capable of detecting a target analyte, such as an antibody, biomarker, or toxin, in a liquid. Unlike conventional tests that tests that require a larger quantity of sample fluid, pre-treatment of the sample, additional chemical components, and/or additional fluids for diluting and/or carrying the sample through the assay, the apparatus and methods described herein are compatible small quantities of bodily fluids without the need for pre-treatment, additional chemicals, or additional fluids.

In some embodiments, the apparatus described herein is intended to enable a user to discretely test a beverage for the presence of a harmful substance, such as a sedative or date rape drug, prior to consuming the beverage. Thus, in some embodiments, the apparatus is designed to be small in size and to provide results rapidly. In some cases, the apparatus may provide results in less than 2 minutes and in some cases in less than 30 seconds. In some cases, a sample may be applied to a detection unit for testing indirectly by using a hand, swab, or other tool to collect the sample and place the sample in contact with the apparatus.

In some cases, the apparatus may be self-contained without requiring additional packaging or buffers during use of the apparatus or to maintain function over time. For example, all of the buffer components may be dried down onto a portion of the detection unit (e.g., a pad) so that additional buffers need not be added during operation of the assay. In some embodiments, built-in desiccant and foil seal may provide stability beyond a year of manufacture so the apparatus has a long shelf-life.

Certain embodiments described herein provide an adaptable apparatus for detecting the presence of a compound in a liquid, where the apparatus includes a lateral flow assay. Apparatuses, systems, and methods for detecting a target substance, including lateral flow assays and buffer systems, are described and set forth in patent applications: PCT/US17/15504, filed Jan. 27, 2017; PCT/US17/15489, filed Jan. 27, 2017; PCT/US17/15500, filed on Jan. 27, 2017; U.S. Ser. No. 15/449,701, filed Mar. 3, 2017; and U.S. Ser. No. 15/449,721, filed Mar. 3, 2017.

In some embodiments, an adaptable apparatus for detecting the presence of a target substance includes a housing that surrounds (or substantially surrounds) a detection unit where the housing includes an entry port through which a fluid external to the housing can enter the housing and contact the detection unit. The housing may include a cavity for receiving the detection unit and a protective layer disposed over the cavity capable of sealing the detection unit. For example, the protective layer may seal the detection unit by preventing a liquid from reaching the detection unit until the apparatus is in use or limiting the flowrate or volume of fluid that reaches the detection unit. Optionally, at least one opening in the protective layer is an entry port through which a fluid external to the housing can enter the housing and contact the detection unit. In some embodiments, the adaptable apparatus further includes a removable layer disposed directly or indirectly over the detection unit such that upon removal of at least a portion of the removable layer, at least a portion of the detection unit is exposed to an external environment. In some embodiments, at least a portion of the removable layer is disposed over an opening in the protective layer, and the opening is an entry port through which a fluid external to the housing can enter the housing and contact the detection unit. In some embodiments, the housing includes a passageway so that the housing is capable of being positioned on or removably attached to a liquid vessel (e.g. a glass) and/or one or more implements. Implements may include, but are not limited to straws, stirrers, rods, novelties (e.g. umbrellas, ice cubes, floating cocktail accessories) generally associated with beverages.

In some embodiments, the detection unit may include colorimetric indicators, electrochemical sensors, a nanofluidic device, a fluorescent assay, a radiolabeled assay, a magnetic assay, a lateral flow immunoassay or other means to detect the presence or absence of the target substance. In some embodiments, the detection unit includes a lateral flow assay.

The detection unit should fit within the housing, and should be protected by the housing or by another feature of the apparatus from contacting any liquid until a user is ready to use the apparatus to test a liquid for a target substance. Optionally, the detection unit is capable of detecting the presence or absence of a target substance in any one of a variety of liquids, so the user has a choice of beverages in which the apparatus will successfully function. Optionally, the detection unit is capable of providing results rapidly, for example, in less than 2 minutes and in some cases in less than 30 seconds. Optionally, the detection unit may be protected by a desiccant until a user is ready to use the apparatus to test a liquid for a target substance. In some cases, the detection unit may be a lateral flow assay.

### Housing

The apparatus described herein includes a housing that has a cavity for receiving a detection unit. Thus, the housing contains the detection unit therein and surrounds or substantially surrounds the detection unit. The housing includes an entry port through which a fluid external to the housing can enter the cavity and contact the detection unit. In some embodiments, the housing comprises a protective layer disposed over the cavity. The protective layer may be coupled to the housing and/or to the detection unit that is in the cavity. Optionally, the protective layer seals the cavity, preventing liquid from contacting the detection unit until a user is ready to test a liquid. In some aspects, the protective layer includes an opening that serves as the entry port through which a fluid external to the housing can enter the cavity and contact the detection unit. In some embodiments, the housing further includes a passageway so that the housing is capable of being positioned on or removably attached to a liquid vessel (e.g. a glass) and/or one or more implements, such as straws, stirrers, rods, or novelties (e.g. umbrellas, ice cubes, floating cocktail accessories), generally associated with beverages. In some cases, the apparatus may be adaptable to variety of implements, where the implements have a diameter smaller than the passageway of the apparatus. In some cases, the housing has a peripheral geometry that is complementary to or compatible with an implement into which the housing can be removably inserted or to which the housing can be removably attached. For example, the periphery of the housing may be substantially circular so that the housing is capable of being removably inserted or attached to one or more implements having an arched or circular opening for receiving the housing such that the implement accommodates the circular housing. In some embodiments, the housing may include first and second opposing faces separated by a thickness. The first and second opposing faces may be substantially planar, and optionally one of the opposing faces may comprise a cavity. The housing may include a peripheral surface connecting the first and second opposing faces and extending around a periphery of the housing. In certain embodiments, the housing may include a passageway from a first opening in the peripheral surface through at least a portion of the housing. In some cases, the housing may be in the shape of a disk, a rod, or a combination thereof. For example, the housing may be a rod with a submersible disk-shaped head connected to the rod.

In some embodiments, the entry port or opening for liquid entry to the cavity and detection unit is small in comparison to the size and surface area of the sealed apparatus. For example, when the apparatus contacts a liquid to be tested, the relatively small opening for liquid presents the only path to the detection unit. Thus, even if the liquid is available in a quantity that could flood the detection unit, the substantially small size of the opening reduces the potential for flooding of the detection unit. In some cases, the area of the entry port comprises less than about 30% of the total surface area of the top of the apparatus, for example, an area of the opening of about 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, and 1%. In some examples, the area of the entry port may be about 1% to 30%. In some cases, the area of the entry port comprises less than about 1% of the total surface area of the top of the apparatus, for example, an area of the opening of about 0.9%, 0.8%, 0.7%, 0.6%, 0.5%, 0.4%, 0.3%, 0.2%, 0.1%. In some examples, the area of the entry port may be about 5% to 0.1%.

In some embodiments, it may be advantageous to limit the volume of the cavity not occupied by the detection unit, for example, to limit the volume of fluid that can enter the cavity. Thus, it may be advantageous for external dimensions of the detection unit to be substantially the same as the internal dimensions of the cavity, i.e., for the detection unit to substantially fill the cavity. In some embodiments, the shape of the cavity may emulate the shape of a detection unit intended to be used in the apparatus. For example, the cavity may be substantially rectangular to accommodate a substantially rectangular detection unit or the cavity may include a mushroom-shape to accommodate a detection unit with an asymmetrical design. In some embodiments, the depth of the cavity may vary to accommodate deeper configurations of the detection unit. For example, the depth of a portion of the cavity may be essentially equivalent to the depth of the housing. The deeper cavity section may increase the size of the detection unit that may be compatible with the housing.

The housing may include a protective layer disposed over the cavity, where the protective layer is capable of sealing the cavity with the detection unit inside, for example, to prevent a liquid from reaching the detection unit or to limit the flowrate or volume of fluid that reaches the detection unit. The protective layer may be integral with the remainder of the housing or may be a separate structure optionally coupled to the remainder of the housing. The protective layer may be formed from a material used in another portion of the housing or may be formed from a different material.

In some embodiments, the protective layer includes at least one opening in the protective layer. Optionally, at least one opening in the protective layer may be the entry port through which a fluid external to the housing can enter the cavity and contact the detection unit. In some aspects, an opening in the protective layer that is an entry port exposes at least a portion of the detection unit and provide a pathway for a liquid to enter the apparatus and reach the exposed portion of the detection unit. The exposed portion of the detection unit may be a sample collection area or sample pad. In some embodiments, at least one opening in the protective layer may be a vent for a gas to leave the cavity. Optionally, a vent is sized such that it allows gas to leave the cavity but does not permit liquid to enter the cavity. In some embodiments, a vent for the detection unit may be integrated within the housing. For example, a small opening may be placed through the housing and into the cavity to allow any gases within the cavity to be vented from the housing. In some examples, a vent opening has an area of no more than 0.2 mm². In some examples, the protective layer may include more than one vent. For example, the protective layer may include several vents for a total area of 0.5 to 0.6 mm². In other examples, the protective layer may include several vents for a total area of 1.0 mm² or more. Alternatively, the protective layer may have no openings, and the entry port and/or a vent described above could be through a portion of the housing other than the protective layer.

In some embodiments, the protective layer includes a window through which the detection unit can be seen. If the protective layer is opaque, a window can permit a user to see an indication of the presence or absence of a target substance where the indication is displayed on the detection unit. While the window permits viewing of the detection unit, it is not open and does not permit liquid or gas to pass through the protective layer at the window.

In some embodiments, the protective layer can be the top layer of the apparatus. In some embodiments, the protective layer may coordinate with the signal from the detection unit, for example, the protective layer may include printing or product branding that may be enhanced by the signal from the detection unit. In some cases, the protective layer may help seal and secure the detection unit within the apparatus.

In some embodiments, the adaptable apparatus may further include a removable layer disposed over the entry port and optionally coupled to a portion of the housing. Upon removal of the removable layer, the entry port is exposed, which exposes at least a portion of the detection unit to an external environment (i.e. an environment external to the housing). When the entry port is an opening in the protective layer, the removable layer is disposed at least over the opening in the protective layer and may be coupled to the protective layer or to another portion of the housing. In certain embodiments, the protective layer may include foil, such as a metallic foil. For example, the protective layer may include aluminum, silver, gold, or platinum foil.

In some embodiments, the detection unit of an apparatus described herein can be used only once, i.e., can test only a single liquid, before it is spent. Thus, a user who has multiple samples to test or wants to monitor an analyte over time would need easy access to multiple different apparatus. Moreover, a user may need the apparatus to be easily portable without risk of loss or damage. Accordingly, in some embodiments, the housing comprises a structure capable of being attached to an implement, such as a straw, stirrer, rod, or novelty (e.g. umbrella, ice cube, floating cocktail accessory), generally associated with beverages. Additionally or alternatively, the housing may have a structure capable of being attached directly or indirectly to a beverage container (e.g. a glass, cup, or bottle), key rings, cellular device, or other personal accessory. Including such structures in a housing facilitates providing an apparatus described herein with each drink served in a bar or other establishment. In some cases, the periphery of the housing is shaped so that the housing is capable of being removably attached to one or more implements of complementary shape.

In some embodiments, the adaptable apparatus may be attached to a beverage container or to an implement such as a drinking straw, a drink stirrer, a novelty commonly associated with beverages, an adaptor (for connecting to a container or implement), a hook, or a rod. In some embodiments, the housing includes a passageway through at least a portion of the housing for accepting at least a portion of an implement. In some aspects, the implement can easily be inserted and removed, but also fits snugly in the passageway so it does not inadvertently become disconnected from the apparatus once inserted. For example, the apparatus may be attached to a drinking straw, or other rod-like implement, by inserting the straw into a passageway that extends at least partially through the apparatus. Optionally, the housing may include more than one passageway for receiving an implement. In certain embodiments, the housing is a rod, which may include a drink stirrer.

In some aspects, the passageway(s) may have any shape necessary to accommodate the desired implement. For example, the passageway may be long and narrow to accommodate a rod-like implement, and the passageway may have any desired cross-sectional shape, such as circular, oval, square, or polygonal (e.g., hexagonal or octagonal). In some aspects, the housing may include more than one passageway, where the passageways have different cross-sectional shapes or sizes (e.g., different diameters for multiple passageways having circular cross-sections) to accommodate various sizes and shapes of implements. In other aspects, a single passageway may have a cross-section that varies along the length of the passageway so that implements of different shapes or sizes each can be inserted into the passageway to different depths, but each implement fits securely within at least a portion of the passageway.

Optionally, a passageway may be substantially through the center longitudinal axis or center lateral axis of the housing. Additionally or alternatively, a passageway may be parallel to and spaced apart from the center longitudinal axis or the center lateral axis of the housing. For example, the passageway may be parallel to the center longitudinal axis but at the edge of the housing. In some cases, a passageway may be substantially through the center lateral axis and another passageway may be parallel to the center lateral axis but at the edge of the housing. In other embodiments, one or more passageways may extend through at least a portion of the housing in any orientation. The specific location of the passageway through the apparatus is not particularly limited so long as the passageway allows attachment of the apparatus to an implement and does not interfere with the functioning of the detection unit in the cavity of the housing.

In some embodiments, the one or more passageways may be enclosed. In some embodiments, the one or more passageways may be defined by the opening at the entrance and exit of each passageway. In some embodiments, the openings may be substantially rectangular in shape. In other embodiments, the openings may be substantially circular in shape. In some embodiments, the openings may be polygonal in shape, for example, hexagonal or octagonal.

In some embodiments, the implement may be a substantially cylindrical or polygonal shape that may be solid or hollow. In some embodiments, the implement may be an adaptor to aid in connecting the apparatus to a desired article. For example, the adaptor may include a stem and secondary connection means. In some embodiments, the adaptor may include an arching open-ended hook. In some embodiments, the adaptor may include a latch or snapable hook. In some embodiments, the apparatus may be connected to the interior of the implement. For example, the apparatus may include a stem that may be inserted into the end of an implement, such as a drinking straw. Optionally, an adaptor with a stem may be inserted into the passageway of the apparatus to connect the apparatus to the interior of the drinking straw or other implement.

The housing may attach to a lip or rim of a container. In some embodiments, the housing may attach directly to the lip or rim of a container. In other embodiments, the housing may attach indirectly by an implement that attaches to the lip or rim of a container. For example, the apparatus may be attached to the rim of a container by inserting an implement into the passageway of the apparatus. In some cases, the implement may be an adaptor having a stem with a connected open hook. For example, the apparatus may be connected to the rim of the container by placing the hook-end of the adaptor-implement over the rim of the container. In some cases, the housing may include a substantially C-shape feature. In some cases, the housing may include a substantially U-shape feature. Optionally, the housing may have increased flexibility at the substantially C-shape or substantially U-shape feature that permits the housing to securely attach to a lip or rim of a container. In some embodiments, the housing may attach to an implement, such as a straw, stirrer, rod, hook, by the substantially C-shape or U-shape feature.

In some embodiments, the housing may further include at least one bridge. Optionally, the bridge may be located proximate to the one or more passageways. The bridge may provide structural support to the housing. In some cases, the bridge may apply a force to the implement thereby aiding in the attachment of the housing to the implement. In some embodiments, the cavity receiving the detection unit may be located within a bridge of the housing.

In some embodiments, the apparatus may have a front face and rear face. In some embodiments, the faces may be substantially planar in shape, i.e., the faces may be essentially flat. In some embodiments, one or both faces may be curved. In some embodiments, a bridge may be located on each face of the apparatus, i.e., a bridge on the front face and a bridge on the rear face. In some examples, the bridges may be oriented perpendicular from one another.

In some embodiments, an apparatus for detecting the presence of a target substance in a liquid may comprise a housing comprising a first end and a second end, a detection unit, and an entry port for the liquid. In certain embodiments, the housing may be a rod. In some embodiments, the apparatus may further comprise a head connected to the first end of the rod. In some embodiments, the apparatus may further comprise a protective layer capable of sealing the detection unit. In some embodiments, the first end of the rod may comprise a cavity. In some embodiments, the head may comprise a cavity. Optionally, the detection unit may be placed within the cavity. In some cases, the shape of the cavity may emulate the shape of the detection unit.

In some embodiments, the head of the apparatus may further comprise a passageway. In some embodiments, the head may further comprise two orifices aligned with the passageway. In some embodiments, the head may be movable along the length of the rod. In some embodiments, the head may cover the cavity comprising the detection unit and may be configured such that upon moving of the head, at least a portion of the detection unit may be exposed to an external environment. Optionally, at least one of the orifices in the head may comprise a cover, where the cover may be configured to be breached by the rod. In such cases, the detection unit is protected by the head until time of use when the user may move the head along the rod, breaching the cover on one of the orifices, and expose a portion of the detection unit. In some embodiments, the head of the stirring device may be integrated with the first end of the rod. In some cases, the head may be located at the end of the rod of the stirring device. In some cases, the head may have a tapered oval shape.

In some embodiments, the apparatus can be placed in contact with a liquid sample. For example, optionally, the apparatus may be placed directly in a liquid sample. In some cases, the user may place the liquid sample on the apparatus by touching their finger or swab to the entry point.

In some cases, the apparatus may be used to stir a beverage. In some cases, the apparatus may be a decorative ornament.

In some embodiments, the housing may be formed by 3D printing, injection molding, casting, stamping, machining, forging, or pressing.

In some embodiments, the housing may include a polymeric material comprising at least one of acrylonitrile butadiene styrene, acrylonitrile butadiene styrene and polycarbonate alloy, acetal polyoxymethylene, liquid crystal polymer, nylon 6-polyamide, nylon 6/6-polyamide, nylon 11-polyamide, polybutylene terepthalate polyester, polycarbonate, polyetherimid, polyethylene, low density polyethylene, high density polyethylene, polyethylene terepthalate polyester, polypropylene, polyphthalamide, polyphenylene sulfide, polystyrene crystal, high impact polystyrene, polysulfone, polyvinylchloride, polyvinylidene fluoride, styrene acrylonitrile, thermoplastic elastomer, thermoplastic polyurethane elastomer, cyclic olefin copolymer, styrene butadiene copolymer, and polymethyl methacrylate (PMMA).

In some embodiments, the protective layer may include polymeric material similar to or identical to material from which the housing is formed. In other embodiments, the protective layer may include a polymeric material different than the housing. For example, the protective layer may include at least one of acrylonitrile butadiene styrene, acrylonitrile butadiene styrene and polycarbonate alloy, acetal polyoxymethylene, liquid crystal polymer, nylon 6-polyamide, nylon 6/6-polyamide, nylon 11-polyamide, polybutylene terepthalate polyester, polycarbonate, polyetherimid, polyethylene, low density polyethylene, high density polyethylene, polyethylene terepthalate polyester, polypropylene, polyphthalamide, polyphenylene sulfide, polystyrene crystal, high impact polystyrene, polysulfone, polyvinylchloride, polyvinylidene fluoride, styrene acrylonitrile, thermoplastic elastomer, thermoplastic polyurethane elastomer, cyclic olefin copolymer, styrene butadiene copolymer, and polymethyl methacrylate (PMMA). In other embodiments, the protective layer may include foils.

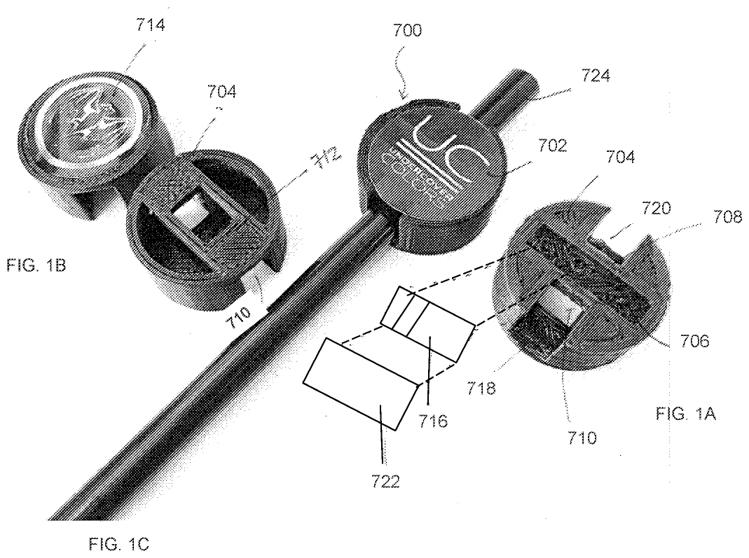

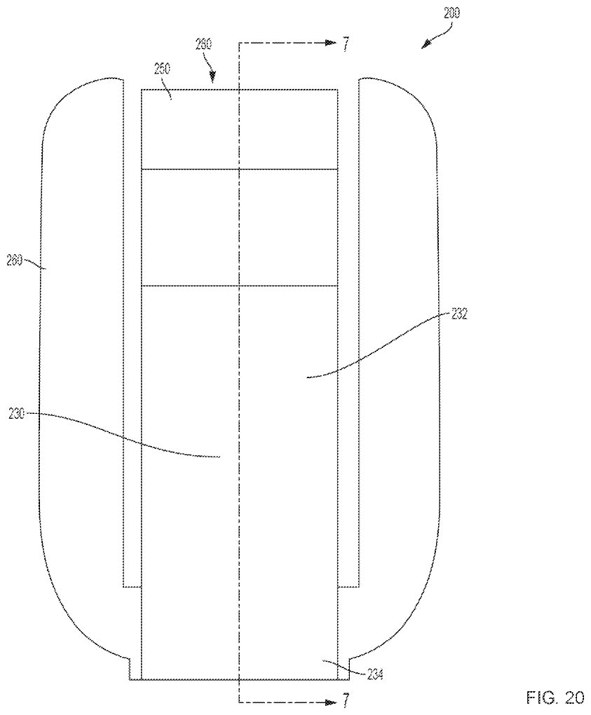

FIGS. 1A and 1B show top and bottom exploded views, respectively, of an apparatus 700 according to one embodiment described herein. A housing 704 has a front face 742, a rear face 744, and a peripheral surface 746. The housing 704 includes orifices 718, 720 in the peripheral surface 746 that define a passageway 710 through the housing 704. The housing 704 also includes a cavity 706 in the front face 742 and a protective layer 722 disposed over the cavity 706 and coupled to the housing with an adhesive backing (not shown). The protective layer 722 has an opening 726 to allow a liquid to enter the cavity 706. The opening 726 is shown as generally circular, but other shapes of opening 726 can be used, for example, oval, rectangular, words, symbols, and emoticons can be used. Moreover, while one opening 726 is shown, more than one opening can be included, for example, two three, four, five, six, or more openings. In some such embodiments, the size of the plurality of openings can be adjusted to a size sufficient to permit a liquid or other medium to travel to a lateral flow assay or detection subassembly for testing and a size that minimize the aesthetic impact of the openings. The assembled apparatus 700 also includes a detection unit 716 disposed in the cavity 706 under the protective layer 722. Embodiments of the detection unit 716 are illustrated in detail in FIGS. 20-23. The protective layer 722 includes a window 728 (not shown) aligned over a portion of the detection unit 716 for viewing an indicator (not shown) that demonstrates presence or absence of a target substance in a tested liquid. A removable layer 702 is disposed over the protective layer 722 and over most of the front face 742. The removable layer 702 is removably coupled to the housing 704 with an adhesive (not shown). An optional decorative layer 714 is shown coupled to the rear face 744 of the apparatus 700. FIG. 1C is a perspective view of the apparatus 700 assembled and attached to an implement 724 (which is not part of the embodiment).

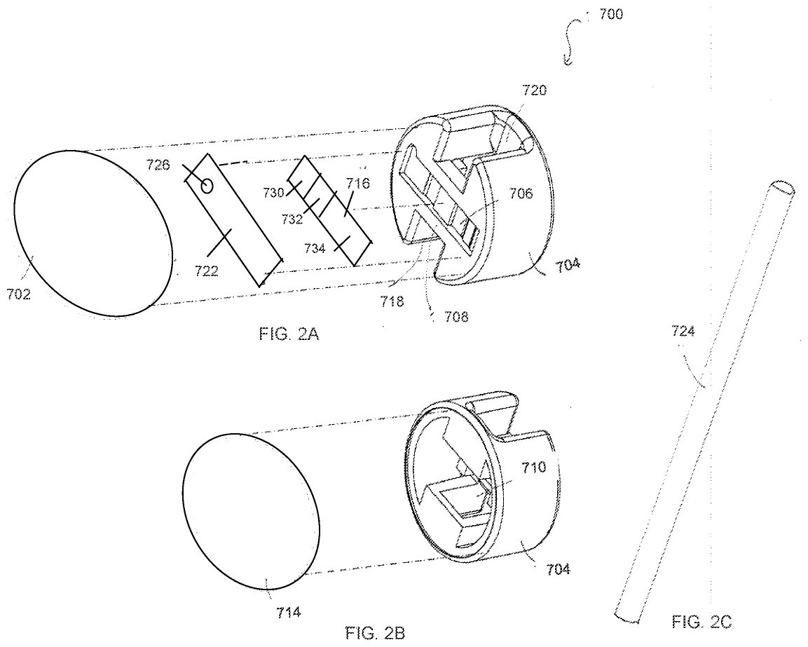

FIGS. 2A and 2B show top and bottom exploded views of an apparatus 700 according to one embodiment described herein. A detection unit (lateral flow assay in this embodiment) 716 is cut, formed and placed in a cavity 706 in the bridge 708 spanning the width of the front face of the housing 704. The lateral flow assay 716 is covered with a protective layer 722. A removable layer 702 is coupled to the housing 704. The passageway 710 runs through the longitudinal axis of the apparatus 700 and provides a passageway for an implement 724, shown in FIG. 2C. The apparatus 700 attaches to the implement 724 by inserting the implement 724 through proximal orifice 718 and distal orifice 720. Protective layer 722 may have an adhesive backing or may be ultrasonically welded or other coupling means. In some embodiments, the protective layer 722 includes an opening 726. Opening 726 of the protective layer can provide an opening through which liquid or other medium can travel to the lateral flow assay for testing. The opening 726 generally overlaps a sample receiving area, e.g., a sample pad-conjugate pad 730 of the lateral flow assay 716. The opening 726 is generally circular, but other shapes of opening 726 can be included, for example, oval, rectangles, words, symbols, and emoticons can be used. In FIG. 2A one opening 726 is shown; in other embodiments, more than one opening can be included, for example, two three, four, five, six, or more openings. In some such embodiments, the size of the plurality of openings can be adjusted to a size sufficient to permit a liquid or other medium to travel to a lateral flow assay or detection subassembly for testing and a size that minimize the aesthetic impact of the openings.

A lateral flow assay 716 comprising a sample pad-conjugate pad 730 and chromatographic membrane pad 732 is coupled to the housing 704. The protective layer 722 is placed over the lateral flow assay 716 in cavity 706 of the housing 704. The removable layer 702 is placed over the front face of the housing, covering the protective layer 722 and lateral flow assay 716. A decorative layer 714 may be coupled to the rear face of the apparatus 700.

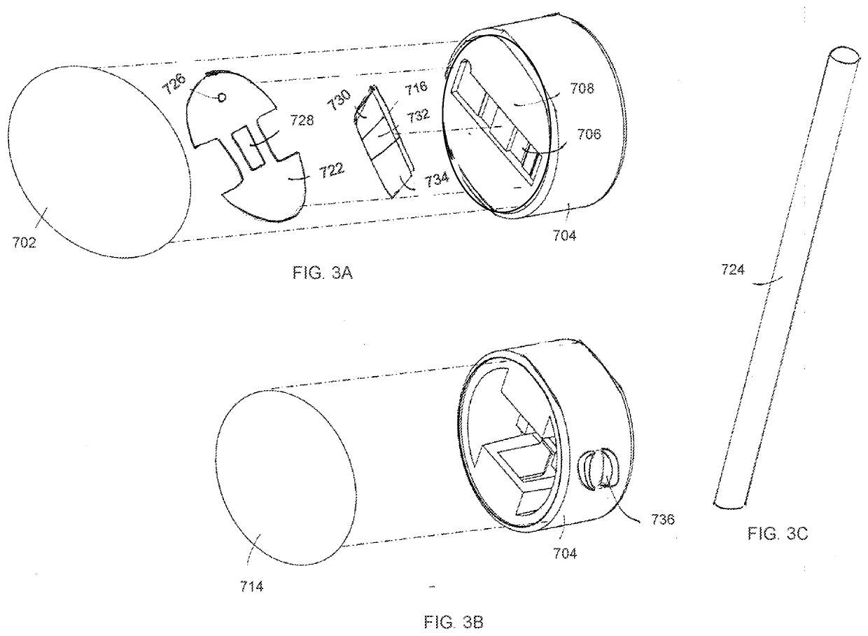

FIGS. 3A, 3B, and 3C show top and bottom exploded views of an apparatus 700 and implement 724 according to one embodiment described herein. A detection unit (lateral flow assay in this embodiment) 716 is cut, formed and placed in a cavity 706 in the bridge 708 spanning the width of the front face of the housing 704. The lateral flow assay 716 is covered with a protective layer 722. A removable layer 702 is coupled to the housing 704. The apparatus 700 attaches to the implement 724 by coupling the implement 724 to clip 736. Here, coupling may be completed by compression fitting or snap the apparatus 700 to the implement 724. In some embodiments, the clip 736 may be C-shaped, U-shaped, or other shape to allow attachment of the apparatus 700 to the implement 724. The coupling of the implement 724 to the apparatus 700 may be by sliding the implement 724 through the clip 736, snapping the clip 736 onto the implement 724, or by other means known by those in the art. The apparatus 700 may be flexible at the clip 736 to aid coupling to the implement 724. Protective layer 722 may have an adhesive backing. In some embodiments, the protective layer 722 includes an opening 726. Opening 726 of the protective layer can provide an opening through which liquid or other medium can travel to the lateral flow assay for testing. The opening 726 generally overlaps the sample pad-conjugate pad 730 of the lateral flow assay 716. The opening 726 is generally circular, but other shapes of opening 726 can be included, for example, oval, rectangles, words, symbols, and emoticons can be used.

A lateral flow assay 716 comprising a sample pad-conjugate pad 730 and chromatographic membrane pad 732 is coupled to the housing 704. The protective layer 722 is placed over the lateral flow assay 716 in cavity 706 of the housing 704. The removable layer 702 is placed over the front face of the housing, covering the protective layer 722 and lateral flow assay 716. A decorative layer 714 may be coupled to the rear face of the apparatus 700.

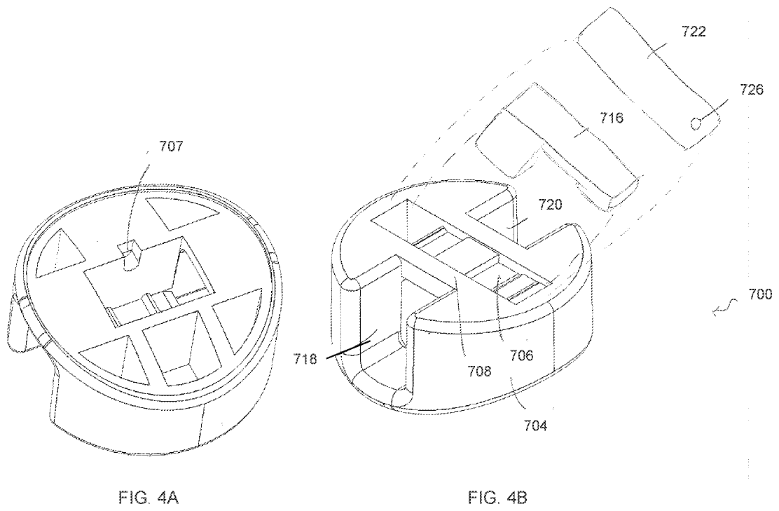

FIGS. 4A and 4B show a top and bottom exploded view of an apparatus 700 according to one embodiment described herein where the surfaces of the apparatus 700 may curved, convex, or concave. A detection unit 716 is placed in a cavity 706 in the bridge 708, which spans the width of the front face of the housing 704. The depth of the cavity 706 may vary. Optionally, the cavity may include a vent 707 within the cavity 706. The detection unit 716 may be covered with a protective layer 722. A removable layer 702 may be coupled to the housing 704. The passageway 710 runs through the longitudinal axis of the apparatus 700 and provides a passageway for an implement 724. The apparatus 700 attaches to the implement 724 by inserting the implement 724 through proximal orifice 718 and optionally, through distal orifice 720. Protective layer 722 may have be coupled to the housing 704. In some embodiments, the protective layer 722 includes an opening 726. Opening 726 of the protective layer can provide an opening through which liquid or other medium can travel to the detection unit for testing.

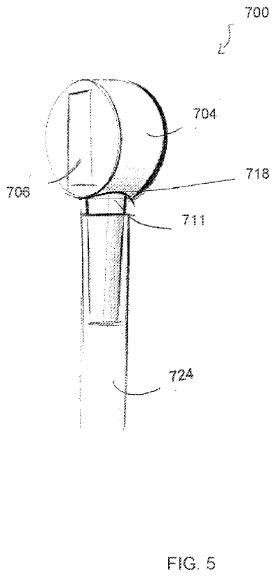

FIG. 5 shows an apparatus 700 according to one embodiment described herein. The housing 704 includes a stem 711 and a cavity 706, which holds the detection unit. Optionally, the stem 711 may be an adaptor that may be inserted into the proximal orifice 718 and passageway 710 of the housing 704. The stem 711 may be inserted into the interior of an implement 724 to connect the apparatus 700 to the implement 724.

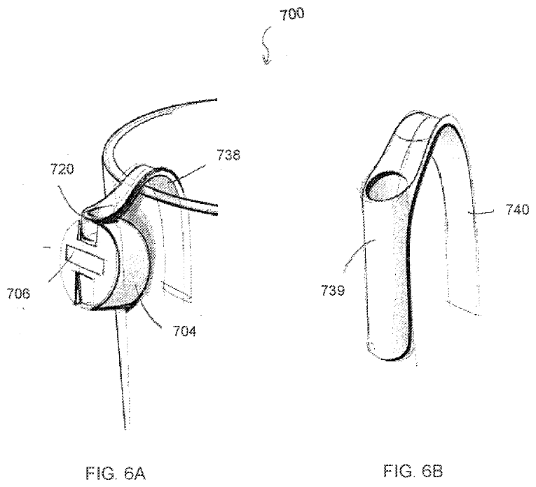

FIGS. 6A and 6B shows an apparatus 700 according to one embodiment described herein. The housing 704 includes a cavity 706, which holds the detection unit. The stem-end 739 of the adaptor-implement 738 may be inserted into the distal orifice 720 of the housing 704 to connect the apparatus 700 to the adaptor-implement 738. The apparatus 700 may be attached to the rim of a container by placing the hook-end 740 of the adaptor-implement 738 over the rim of the container (not shown).

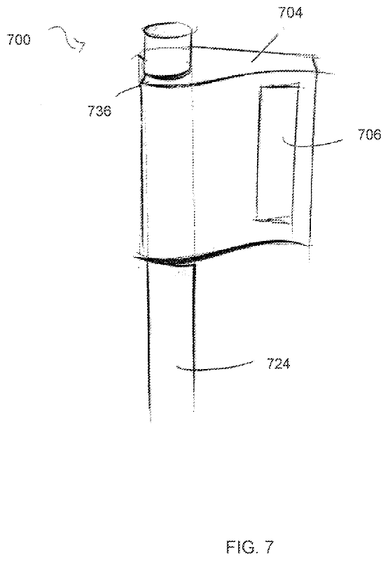

FIG. 7 shows an apparatus 700 according to one embodiment described herein. The housing 704 includes a cavity 706, which holds the detection unit. The housing includes a substantially C-shaped feature 736 that may be compressed around the implement 724 to connect the apparatus 700 to the implement 724.

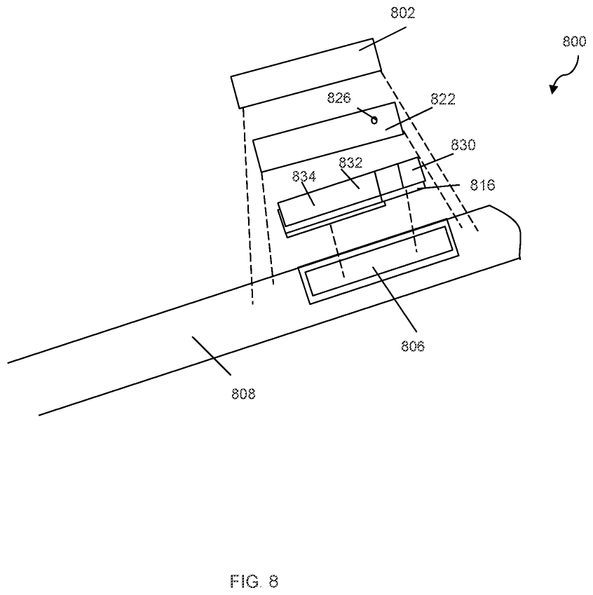

FIG. 8 shows an exploded view of a stirring device with detection apparatus 800 according to one embodiment described herein. A detection unit (lateral flow assay in this embodiment) 816 is disposed in a cavity 806 in the housing (rod) 808 of the device 800, optionally at one end. The lateral flow assay 816 comprises a sample pad-conjugate pad 830 and chromatographic membrane pad 832 and is coupled to the rod 808. The lateral flow assay 816 is covered with a protective layer 822. A removable layer 802, which may be decorative, may be coupled to the rod 808, covering the protective layer 822 and lateral flow assay 816. Protective layer 822 may be coupled to the rod. Opening 826 of the protective layer can provide an opening through which liquid or other medium can travel to the lateral flow assay testing. The opening 826 generally overlaps the sample pad-conjugate pad 830 of the lateral flow assay 816. The opening 826 is shown as generally circular, but other shapes of opening 826 can be included, for example, oval, rectangular, words, symbols, and emoticons can be used. In FIG. 8 one opening 826 is shown; in other embodiments, more than one opening can be included, for example, two three, four, five, six, or more openings. In some such embodiments, the size of the plurality of openings can be adjusted to a size sufficient to permit a liquid or other medium to travel to a lateral flow assay or detection subassembly for testing and a size that minimize the aesthetic impact of the openings.

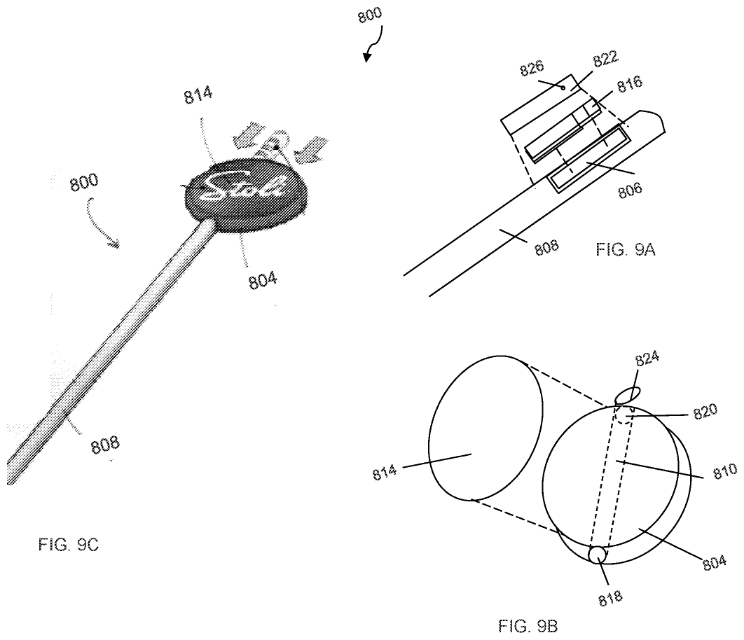

FIGS. 9A, 9B, and 9C show an exploded view of a stirring device with detection apparatus 800 according to one embodiment described herein. As shown in FIG. 9A, a detection unit 816 is cut, formed and placed in a cavity 806 at the end of the rod 808 of the device 800. The lateral flow assay 816 is covered with a protective layer 822. As shown in FIGS. 9B and 9C, the head 804 attaches to the rod 808 by inserting the rod 808 through proximal orifice 818 and passageway 810. The head 804 may move along the rod 808 and the end of the rod 808 may move pass through distal orifice 820 by breaching orifice cover 824. When the rod breaches orifice cover 824, the lateral flow assay 816 may be exposed for use. Optionally, a removable layer may be placed over the end of the rod 808, covering the protective layer 822 and lateral flow assay 816. The passageway 810 runs through the longitudinal axis of the device 800 and provides a passageway for rod 808. In FIGS. 9B and 9C, the head 804 has a generally circular or disc appearance. In other embodiments, the head may have various shapes, including oval, triangular, square, rectangular, pentagonal, hexagonal, heptagonal, octagonal, nonagonal, polygonal, sphere, prism, etc.

Protective layer 822 may have be coupled to the device. In some embodiments, the protective layer 822 includes an opening 826. Opening 826 of the protective layer can provide an opening through which liquid or other medium can travel to the lateral flow assay testing. The opening 826 generally overlaps the sample pad-conjugate pad 830 of the lateral flow assay 816. A lateral flow assay 816 comprising a sample pad-conjugate pad 830 and chromatographic membrane pad 832 is coupled to the rod 808. The protective layer 822 is placed over the lateral flow assay 816 in cavity 806 of the rod 808. The head 804 is placed over the rod 808, covering the protective layer 822 and lateral flow assay 816. A decorative layer 814 may be coupled to the head 804.

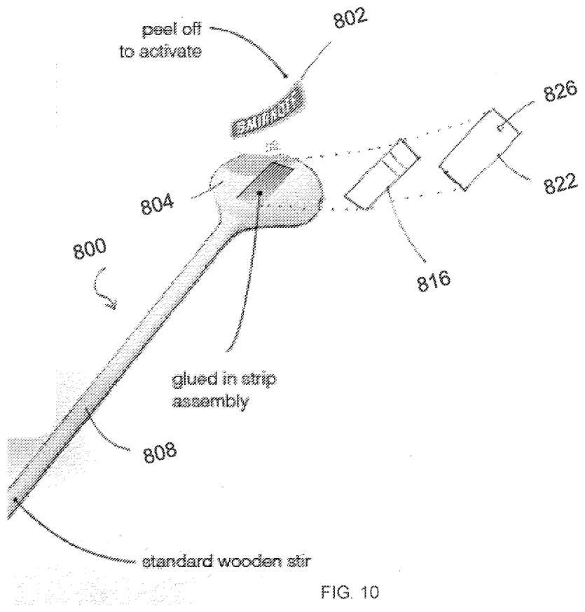

FIG. 10 shows an exploded view of a stirring device with detection apparatus 800 according to one embodiment described herein. In some embodiments, the head 804 is integrated with the rod 808 of the device 800. In FIG. 10, the head 808 has a substantially oval shape with a taper to the rod 808. In other embodiments, the head may have various shapes, including oval, triangular, square, rectangular, pentagonal, hexagonal, heptagonal, octagonal, nonagonal, polygonal, sphere, prism, etc. A lateral flow assay 816 is cut, formed and placed on the head 804 of the device 800. Optionally, the lateral flow assay 816 may be placed within cavity 806 on the head 804. The lateral flow assay 816 is covered with a protective layer 822. A removable layer 802 may be coupled to the head 804. Protective layer 822 may be coupled to the housing 804. In some embodiments, the protective layer 822 includes an opening. Opening 826 of the protective layer can provide an opening through which liquid or other medium can travel to the lateral flow assay testing. The opening 826 generally overlaps the sample pad-conjugate pad 830 of the lateral flow assay 816.

A lateral flow assay 816 comprising a sample pad-conjugate pad 830 and chromatographic membrane pad 832 is coupled to the head 804. The protective layer 822 is placed over the lateral flow assay 816 of the device 800. The removable layer 802 is placed on the head 804, covering the protective layer 822 and lateral flow assay 816. A decorative layer 814 may be coupled to the head 804. In some embodiments, the removable layer 802 and the decorative layer 814 may be a single layer.

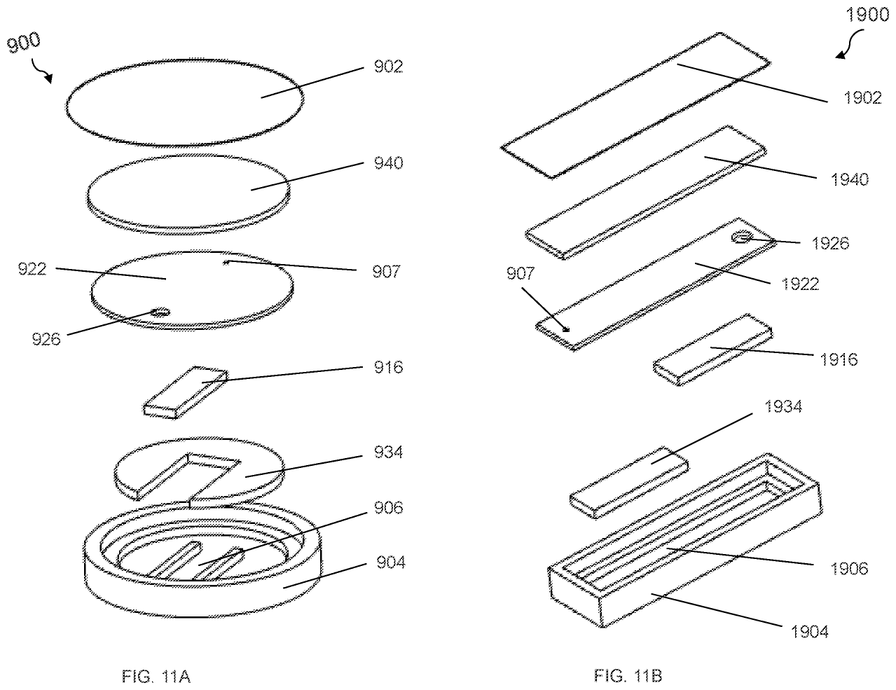

FIG. 11A shows an exploded view of an apparatus 900 according to one or more embodiments described herein. In FIG. 11A, the housing 904 has a substantially circular shape and includes a cavity 906, which holds the detection unit 916. In other embodiments, such as FIG. 11B, the housing 1904 may have various shapes, including oval, triangular, square, rectangular, pentagonal, hexagonal, heptagonal, octagonal, nonagonal, polygonal, sphere, prism, etc. In the assembled apparatus, a lateral flow assay 916 is placed in the cavity 906 of the housing 904 of the device 900. In the assembled apparatus, the lateral flow assay 916 is covered with the protective layer 922. A removable layer 902 may be coupled to the housing 904.

Protective layer 922 may be coupled to the housing 904. In some embodiments, the protective layer 922 includes an opening 926, which can provide an entry point through which liquid or other medium can travel to the lateral flow assay 916 for testing. The opening 926 generally overlaps a receiving area, e.g., a sample pad-conjugate pad (not shown) of the lateral flow assay 916. In FIG. 11A, an absorbent pad (or wick) 934 is substantially U-shaped and planar with the lateral flow assay 916. In some embodiments, the cavity 906 of the housing 904 may be shaped to include a pocket (e.g., a recessed region) for containing the absorbent pad 934. The apparatus 900 optionally includes a removable desiccant 940 placed between the removable layer 902 and the protective layer 922.

In some cases, the shape of the periphery of the removable layer 902, desiccant 940, protective layer 922 may be substantially the same as the periphery of the housing 904, but they need not be. As shown in FIG. 11A, in certain embodiments, the periphery of the housing 904 may be substantially circular.

FIG. 11B shows an exploded view of an apparatus 1900 according to one or more embodiments described herein. In FIG. 11B, the housing 1904 has a substantially rectangular shape and includes a cavity 1906, which holds the detection unit 1916. In other embodiments, the housing may have various shapes, including oval, triangular, square, rectangular, pentagonal, hexagonal, heptagonal, octagonal, nonagonal, polygonal, sphere, prism, etc. In an assembled apparatus, lateral flow assay 1916 is in the cavity 1906 of housing 1904 of the device 1900. In the assembled apparatus, the lateral flow assay 1916 is covered with a protective layer 1922. A removable layer 1902 may be coupled to the housing 1904. Protective layer 1922 may be coupled to the housing 1904. In some embodiments, the protective layer 1922 includes an opening 1926, which can provide an entry point through which liquid or other medium can travel to the lateral flow assay 1916 for testing. The opening 1926 generally overlaps a part of the lateral flow assay 1916. In FIG. 11B, the absorbent pad (wick) 1934 is substantially rectangular in shape. In some embodiments, the cavity 1906 of the housing 1904 may be shaped to include a pocket (e.g., a recessed region) for holding the absorbent pad 1934. The apparatus 1900 may include a removable desiccant 1940 placed between the removable layer 1902 and the protective layer 1922.

In some cases, the shape of the periphery of the removable layer 1902, desiccant 1940, protective layer 1922 may be substantially the same as the periphery of the housing 1904, but it need not be. As shown in FIG. 11B, in certain embodiments, the periphery may be substantially rectangular.

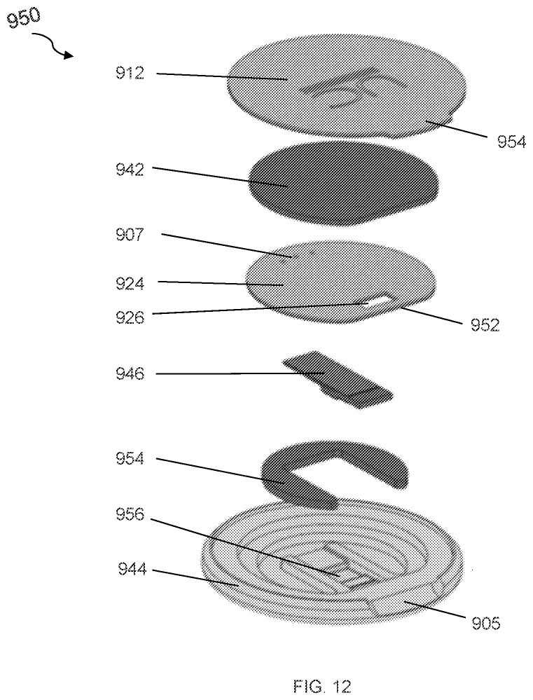

FIG. 12 shows an exploded view of an apparatus 950 according to one or more embodiments described herein. The housing 944 has a substantially circular shape and includes a cavity 956, which holds the detection unit 946. A lateral flow assay 946 is disposed in the cavity 956 of the housing 944 of the device 950. The lateral flow assay 946 is covered with a protective layer 924. A removable layer 912 may be coupled to the housing 944. Protective layer 924 may be coupled to the housing 944. In some embodiments, the protective layer 924 includes an opening 926, which can provide an opening through which liquid or other medium can travel to the lateral flow assay 946 for testing. The opening 926 generally overlaps the sample pad-conjugate pad of the lateral flow assay 946. The absorbent pad (wick) 954 is substantially U-shaped and planar with the lateral flow assay 946. In some embodiments, the cavity 956 of the housing 944 may be shaped to include a pocket for the absorbent pad 954. The apparatus 950 may include a removable desiccant 942 placed between the removable layer 912 and the protective layer 924.

The housing may include a notch or indentation 905 to aid in the removal of the removable layer 912. In some cases, the shape of the periphery of the removable layer 912, desiccant 942, protective layer 924 may be substantially the same as the periphery of the housing 944. As shown in FIG. 12, in certain embodiments, the periphery may be substantially circular and may include a straight edge 952. The removable layer 912 may include a feature such as a tab 954 to aid in the removal of the removable layer from the housing 944 for testing.

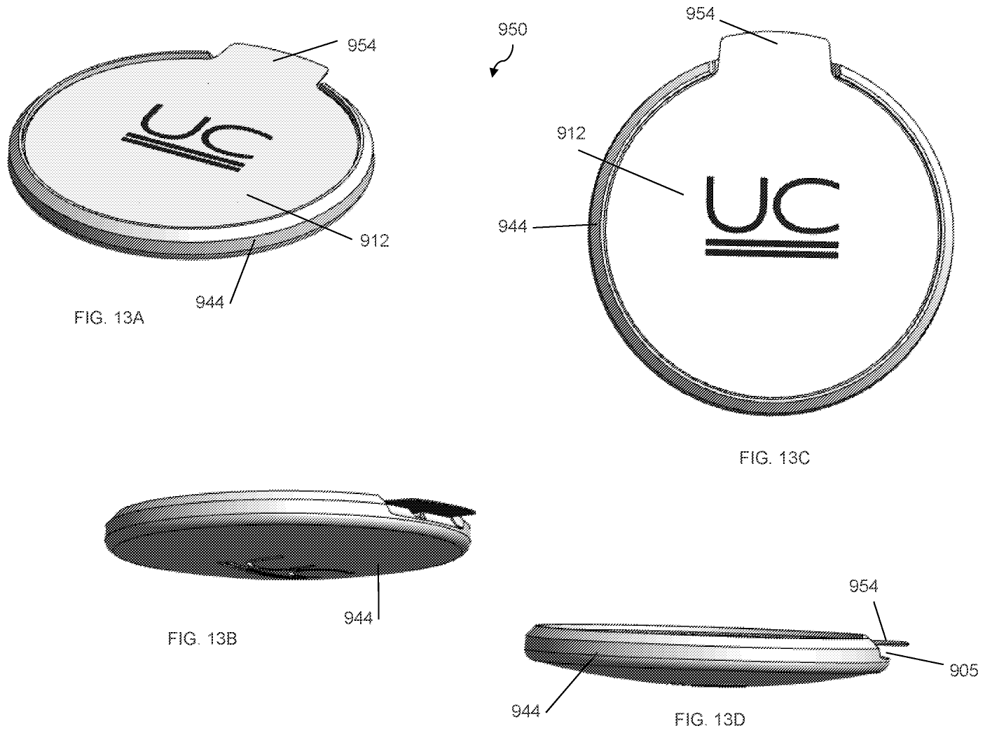

FIGS. 13A, 13B, 13C, and 13D show apparatus 950 according to one embodiment described herein. The removable layer 912 is attached to the housing 944. The periphery of the housing 944 is substantially circular, with a notch or indentation 905 on one side. The removable layer 912 includes a tabbed feature 954 to aid its removal from the housing 944. The removable layer 912 may be substantially planar. The bottom of housing 944 may be planar or may be domed as shown in this embodiment.

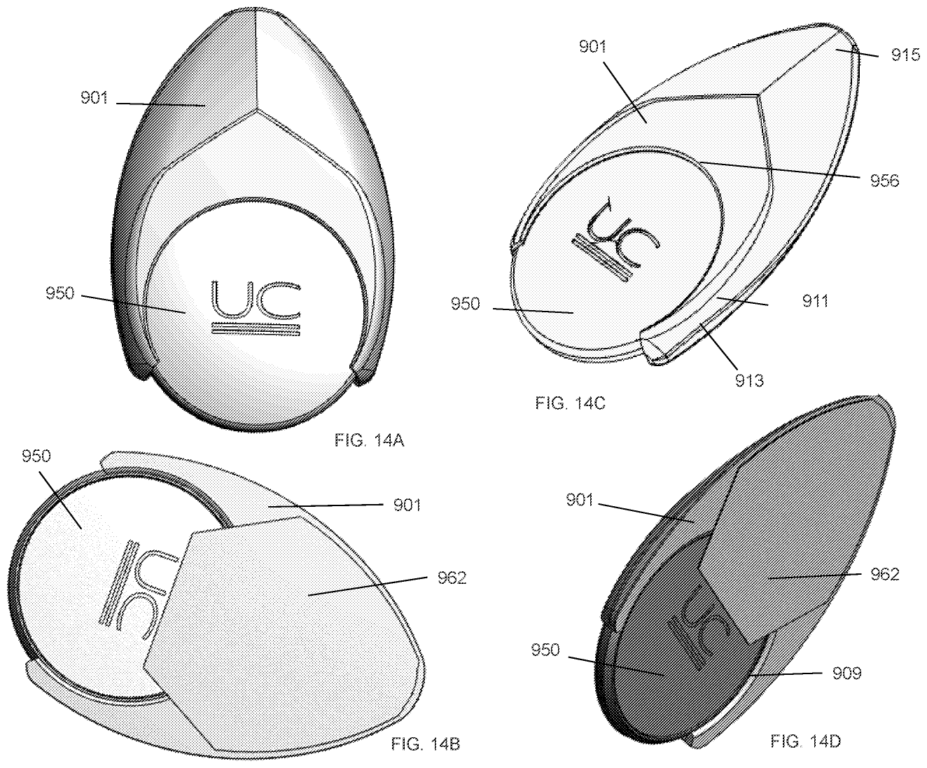

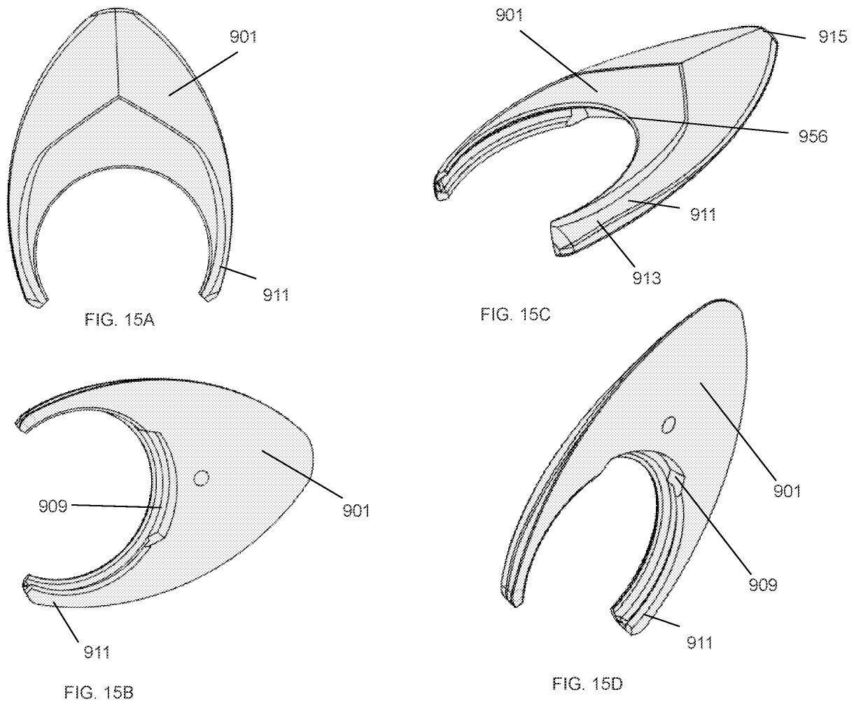

FIGS. 14A, 14B, 14C, and 14D show the apparatus 950 connected to an implement 901 according to one embodiment described herein. FIGS. 15A, 15B, 15C, and 15D show an implement 901 according to one embodiment described herein without an apparatus 950. The implement 901 includes an arched opening 956 that is substantially the same or smaller in size than the width of the housing of the apparatus 950. The implement 901 includes a proximate end 913 with the arched opening 956 and arms 911. In some cases, the arms 911 may flex to provide for insertion of the apparatus 950 into the arched area 956 or provide tension to retain the apparatus 950 in position. Alternatively, the arms 911 may not exert tension/pressure on the apparatus 950 when it is in position, i.e., the arms may be fully relaxed when the apparatus 950 is in position. Instead the geometry of the arms 911 may keep the apparatus in place. The bottom of the implement 901 may include a support ledge 909 to help maintain the position of the apparatus 950 within the implement 901. In some cases, the implement 901 may be attached or connected to a device, such as a cellular device, using adhesive, silicone, or other means known to those in the art. In certain embodiments, a removable adhesive strip 962 may be attached to the implement 901.

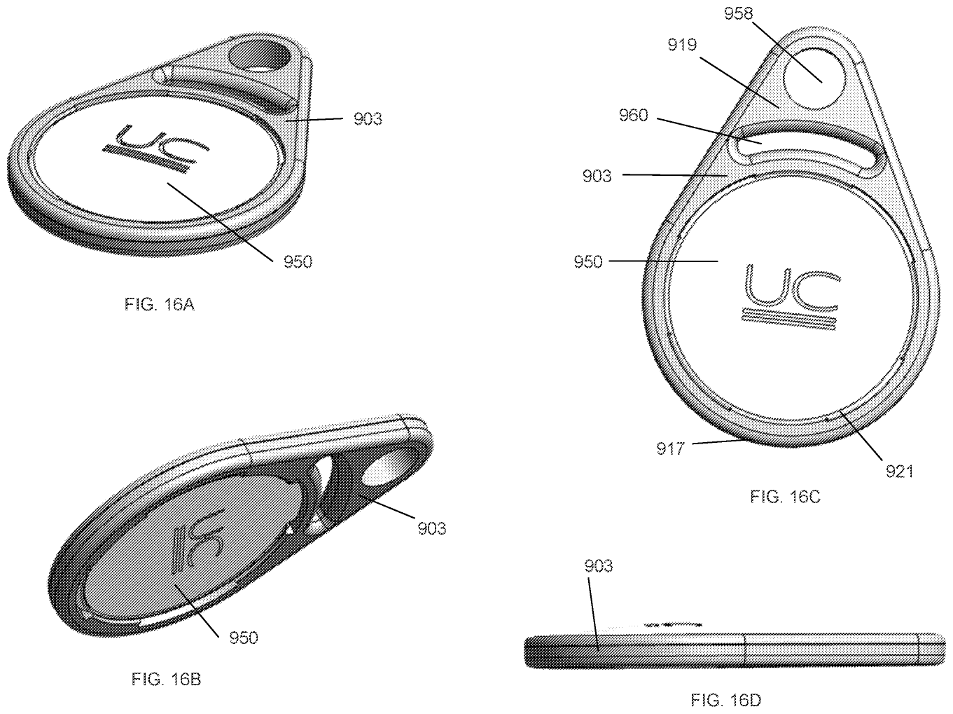

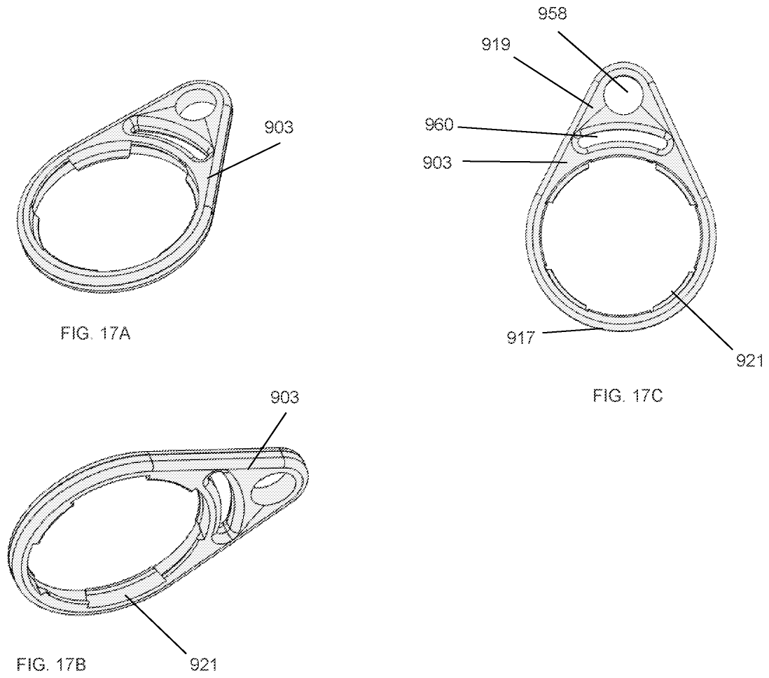

FIGS. 16A, 16B, 16C, and 16D show the apparatus 950 connected to an implement 903 according to one embodiment described herein. FIGS. 17A, 17B, and 17D show an implement 903 according to one embodiment described herein without an apparatus 950. The implement 903 includes an inner support ring 921 that is substantially the same in shape and in size as the width of the housing 904 of the apparatus 950. The implement 903 includes a proximate end 917 and a distal end 919. In some cases, the distal end may include an one or more openings 958. In some cases, the inner support ring 921 may flex to provide for movement of the apparatus 950 into the ring area 921 and provide tension to retain the apparatus 950 in position. A groove 960 between the apparatus 950 and the distal end 919 allows the inner support ring 921 to expand in all directions. In some cases, the implement 903 may be attached or connected to a key ring, lanyard, bag, or jewelry using the opening 958. The implement 903 may be substantially planar in profile.

For a variety of reasons including aesthetics, discretion, and rapid results, in some embodiments it is advantageous for the apparatus described herein to have a relatively small size. For example, in some embodiments, the apparatus has a thickness less than 20 mm, for example, 19 mm or less, 18 or less, 17 mm or less, 16 mm or less, 15 mm or less, 14 mm or less, 13 mm or less, 12 mm or less, or 11 mm or less. In some embodiments, the apparatus has a thickness less than 10 mm, for example, 9 mm or less, 8 or less, 7 mm or less, 6 mm or less, 5 mm or less, 4 mm or less, 3 mm or less, or 2 mm or less.

In some embodiments, the longest external dimension of the apparatus is less than 50 mm, for example, 48 mm or less, 46 or less, 44 mm or less, 42 mm or less, 40 mm or less, 38 mm or less, 36 mm or less, 34 mm or less, 32 mm or less, 30 mm or less, 28 mm or less, or 26 mm or less. In some embodiments, the longest external dimension of the apparatus is less than 25 mm, for example, 24 mm or less, 22 or less, 20 mm or less, 18 mm or less, 16 mm or less, 14 mm or less, 12 mm or less, 10 mm or less, 9 mm or less, 8 mm or less, 7 mm or less, 6 mm or less, or 5 mm or less. In some embodiments, the apparatus has a length less than 250 mm, for example, 240 mm or less, 230 or less, 220 mm or less, 210 mm or less, 200 mm or less, 190 mm or less, 180 mm or less, 170 mm or less, 160 mm or less, 150 mm or less, 140 mm or less, 130 mm or less, 120 mm or less, or 110 mm or less. In some embodiments, the apparatus has a length less than 100 mm, for example, 90 mm or less, 80 or less, 70 mm or less, 60 mm or less, or 50 mm or less.

In some embodiments, the apparatus is in the shape of a disc having a diameter less than 50 mm, for example, 48 mm or less, 46 or less, 44 mm or less, 42 mm or less, 40 mm or less, 38 mm or less, 36 mm or less, 34 mm or less, 32 mm or less, 30 mm or less, 28 mm or less, or 26 mm or less. In some embodiments, the apparatus has a diameter less than 25 mm, for example, 24 mm or less, 22 or less, 20 mm or less, 18 mm or less, 16 mm or less, 14 mm or less, 12 mm or less, 10 mm or less, 9 mm or less, 8 mm or less, 7 mm or less, 6 mm or less, or 5 mm or less.

### Detection Unit

The detection unit of an apparatus according to embodiments described herein is capable of detecting the presence of a targeted substance in any one of a variety of liquids. In some embodiments, the target substance may include any one of: amine-containing compound, benzodiazepine, narcotic, alcohol, date rape drug, pesticide, steroid, steroid metabolite, bacteria, pathogen, fungus, poison, toxin, explosive, explosive precursor material, metal, protein, and sugars.

Described herein are methods and apparatus for detecting the presence of a target substance. In some embodiments, the methods and apparatus can detect a target compound in a liquid. In some embodiments, the methods and apparatus can detect a target substance in a solid. For example, the methods and apparatus described herein can be used for real-time detection of illicit drugs, e.g., amine-containing compounds or drugs, benzodiazepines, amine-containing compounds or drugs, analytes, abused narcotics, alcohol, drugs, date rape drugs, or other target compounds or analytes. As another example, the methods and apparatus described herein can be used for real-time detection of certain proteins, sugars, or allergens, e.g., gluten, peanut proteins, or lactose. In some embodiments, the methods and apparatus described herein can be used for real-time detection of other materials, for example, pesticides, steroids and their metabolites, bacteria, pathogens, fungi, poisons, toxins, chemical warfare agents, environmental poisons, explosives and the starting materials used to make them, as well as mixtures of small molecules, metals, volatile organics, and other targeted compounds.

In some embodiments, the methods and apparatus described herein can used for real-time detection of targeted substances, analytes, or compounds within ketamine, 4-hydroxybutanoic acid (GHB), ephedrine, methamphetamine, amphetamine, flunitrazepam, 3,4-methylenedioxy-methamphetamine (MDMA), also known as ecstasy or molly, tetrahydrocannabinol (THC), and benzodiazepines such as clonazepam and others, and many more. In some embodiments, the methods and apparatus described herein can used for real-time detection of targeted substances, analytes, or compounds within foods or liquids.

In some examples, the liquid comprises a consumable liquid. For example, the consumable liquid can be include beer, cider, energy drinks, flavored drinks, fruit drinks, liquor or other alcoholic beverages, milk, milk-containing beverages, soda, sports drinks, vegetable drinks, water, wine, and combinations thereof. In some examples, the liquid comprises a non-consumable liquid (e.g., blood, non-potable water, organic solvents, potable water, serum, treated waste water, untreated waste water, urine, vomit, sweat, tears, reproductive fluids, other bodily secretions, or combinations thereof). The liquid can comprise a solution, a suspension, or an emulsion. In some examples, the liquid can contain solid particles or ice suspended therein. In some examples, the liquid medium can include liquid extract from a solid. In other cases, the methods and apparatus can be used to detect analytes in a solid material, such as extracting gluten from bread. In some examples, the methods and apparatuses can be used to detect analytes in nutritional supplements, cosmetics, or soil. In further examples, the methods and apparatus can be used to detect the presence of heavy metals. In some cases, the methods and apparatus can be used to detect analytes from a gas that has been bubbled through a liquid, where the liquid absorbs at least some of the analyte from the gas and the methods and apparatus described herein test the liquid.

In some embodiments, the detection unit can detect one or more target substances in any one of a variety of liquids. For example, the detection unit can detect one or more target substances in a liquid containing alcohol ranging from 0 to 90% by volume (e.g., 10%, 25%, 50%, 65%, 80% by volume, or any intermediate % by volume), sugar in concentrations ranging from 0 to 0.5 g/mL (e.g., 0.05-0.4 g/mL, 0.1 to 0.3 g/mL), and/or in a liquid having a pH ranging from about 2 to about 10 (e.g., in acidic liquids having a pH from about 2 to about 5, or from about 2 to about 4, and/or in basic liquids having a pH from about 8 to about 10). The detection unit may detect one or more target substances in colorless and colored liquids, including those with artificial coloring or natural pigmentation. The detection unit may detect one or more target substances regardless of the transparency of the liquid, i.e., transparent, translucent, turbid, or opaque liquids.

In some embodiments, the detection unit may include colorimetric indicators, electrochemical sensors, a nanofluidic device, a fluorescent assay, a radiolabeled assay, a magnetic assay, a lateral flow immunoassay or other means to detect the presence or absence of the target substance. In some embodiments, the detection unit is a lateral flow assay.

In some embodiments, the detection unit includes an area for receiving a sample of a liquid for testing. For example, the area for receiving a sample may be a sample pad. When the detection unit is disposed in the cavity of an apparatus described herein, the sample pad may be aligned with the entry port (i.e., the opening in the protective layer when that is the entry port), so that a liquid external to the housing enters the cavity through the entry port and contacts the sample area of the detection unit.

In certain embodiments, a sample pad material can be included within the detection unit. The sample pad can aid in the wetting of the detection unit. The sample pad can limit the amount of liquid that flows into the apparatus. In some embodiments, once the sample pad is saturated, the rate of absorption of the liquid can decrease and thus limit the amount of liquid that is absorbed, controlling the flow of the liquid into the apparatus.

The detection unit may also include an area for displaying an indicator that demonstrates the presence or absence of a target substance in a tested liquid. For example, the area for displaying an indicator may be a chromatographic membrane pad that comprises a marker. The marker may be configured to display an indication upon a detection of the target substance (e.g., upon reaction with the target substance or upon reaction with another substance in the absence of the target substance). The indication may be a visual indication that the target substance is present or absent.

In some embodiments, the absorbent capacity of the wick or absorbent pad may also reduce the potential for back flow. For example, the wick or absorbent pad may have an absorbent pad capacity substantially greater than the intended sample volume of the detection unit; the substantially greater absorbent pad capacity may reduce the potential for backflow by ensuring virtually all of the sample and companion detection unit chemicals are drawn into the absorbent pad. In some embodiments, the capacity of the absorbent pad may be 50 to 100% greater than the intended sample volume. In some cases, the capacity of the absorbent pad may be 3 to 5 times greater than the sample volume needed for the test.

In some embodiments, the detection unit is a lateral flow assay and may include an assay sample pad, a conjugate pad, a chromatographic membrane pad, and an absorbent pad (or wick). The pads may contact, abut or overlap one another. The sample pad may directly or indirectly contact the conjugate pad so a sample liquid can flow from the sample pad to the conjugate pad. The conjugate pad may directly or indirectly contact the chromatographic membrane pad so a sample liquid can flow from the conjugate pad to the chromatographic membrane pad. The chromatographic membrane pad may directly or indirectly contact the absorbent pad so a sample liquid can flow from the chromatographic membrane pad into the absorbent pad. The chromatographic membrane pad may include a marker that is capable of displaying a signal detection of a target substance. The signal may be a visual indication that the target substance is present or absent in the liquid being tested. In some embodiments, the absorbent pad may overlap a portion of the chromatographic membrane pad, and may be configured to draw the liquid from the chromatographic membrane pad. In some embodiments, the size of the absorbent pad may be increased to aid in larger amounts of sample. In some embodiments, the shape of the absorbent pad may be designed so that a length of a path traversed by a liquid through the detection unit from the sample pad through the absorbent pad is longer than any external dimension of the detection unit. In some cases, the path traversed by the liquid through the detection unit is 2 or 3 times as long as the longest external dimension of the detection unit.

In some embodiments, the detection unit comprises a lateral flow assay. In some embodiments, the lateral flow assay can rely on antibody-analyte interactions to determine the presence of drugs in an alcoholic or non-alcoholic beverage. In some embodiments, the lateral flow assay can rely on aptamer-analyte interactions to determine the presence of an analyte in a liquid. In some aspects, a molecularly imprinted polymer, a biomimetic polymer (such as a peptoid), or another molecular recognition method may be used in place of an antibody or aptamer for detecting the target analyte.

In some embodiments, the lateral flow assay can include an anti-drug antibody that is conjugated to colored particles which can be carried through a chromatographic membrane upon which a drug-conjugated protein (test line) and an anti-species antibody (control line) are immobilized. In some embodiments, the colored particles can include gold nanoparticles. In some embodiments, the colored particles can include dye-infused latex microbeads. In some embodiments, the chromatographic membrane can include cellulose, nitrocellulose, glass fiber, similar materials, or a combination of these materials. Lateral flow assays that can be used in the described apparatus can include, for example, those described and set forth in a PCT patent application PCT/US2017/015489.

In some embodiments, upon exposure of the detection unit comprising a lateral flow assay to a beverage, the fluid absorbed by the detection unit can move through the detection unit carrying with it the anti-drug antibody-particle conjugate so that it passes over the immobilized drug-protein conjugate and anti-species antibody. If no drug is present the anti-drug antibody-particle conjugate will interact and bind to the drug-protein conjugate as well as the anti-species antibody which will cause the anti-drug antibody-particle conjugate to become immobilized as well. The immobilization of the anti-drug antibody-particle conjugate can result in the deposition of color on the areas where the drug-protein conjugate (test line) and anti-species antibody (control line) are located. In the case where drug is present in the beverage, the drug will bind the anti-drug antibody-particle conjugate in turn preventing the anti-drug antibody-particle conjugate from interacting with and binding the drug-protein conjugate (test line). Because the drug inhibits the interaction and binding between the anti-drug antibody-particle conjugate and the test line, no color will be deposited in this area. Because the interaction and binding of the anti-drug antibody-particle conjugate with the anti-species antibody (control line) is not impacted by the presence of drug, there will still be deposition of the color on the control line. In some embodiments, a result indicating no drug is present consists of two lines (test and control lines are colored) while a result indicating that drug is present consists of one lines (control line is colored). In other embodiments, a result indicating the target analyte is present consists of one line (control line is colored) while a result indicating that the analyte is not present consists of two lines (test and control lines are colored).

In some embodiments, the detection unit comprising a lateral flow assay includes a buffering agent. The buffering agent can modify the properties of the absorbed samples to make the solution compatible with the antibody-particle conjugate. The buffering agents can include additives such as organic and inorganic acids, salts, ionic and non-ionic detergents, sugars, and proteins. Buffers that can be used in the described apparatus can include, for example, those described and set forth in PCT/US2017/015489. In some embodiments, the additives can also serve the function of preparing the membrane pad(s) for the flow of the liquid sample through the unit. These additives can facilitate flow of the sample through the membrane while simultaneously preventing unwanted interactions between the membrane and the anti-drug antibody-particle conjugate, drug-protein conjugate, and anti-species antibody. The concentrations and combination of reagents tend to be dictated by the sample matrix being tested.

In some embodiments a detection unit comprises a chromatographic membrane pad capable of receiving a liquid and allowing for migration of the liquid. In some instances, the chromatographic membrane can include an anti-analyte antibody-particle conjugate at at least a first location and an analyte-conjugate protein at at least a second location. In some embodiments, the chromatographic membrane pad further comprises an anti-species antibody at at least a third location.

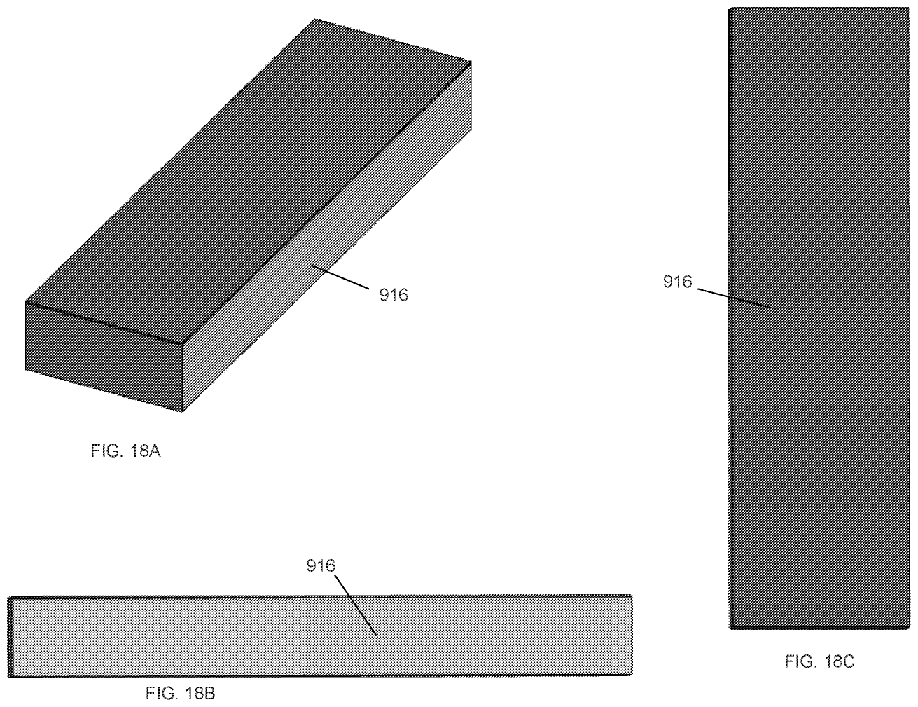

FIGS. 18A, 18B, and 18C show the detection unit for the adaptable apparatus according to one embodiment described herein. The detection unit may be substantially rectangular in shape.

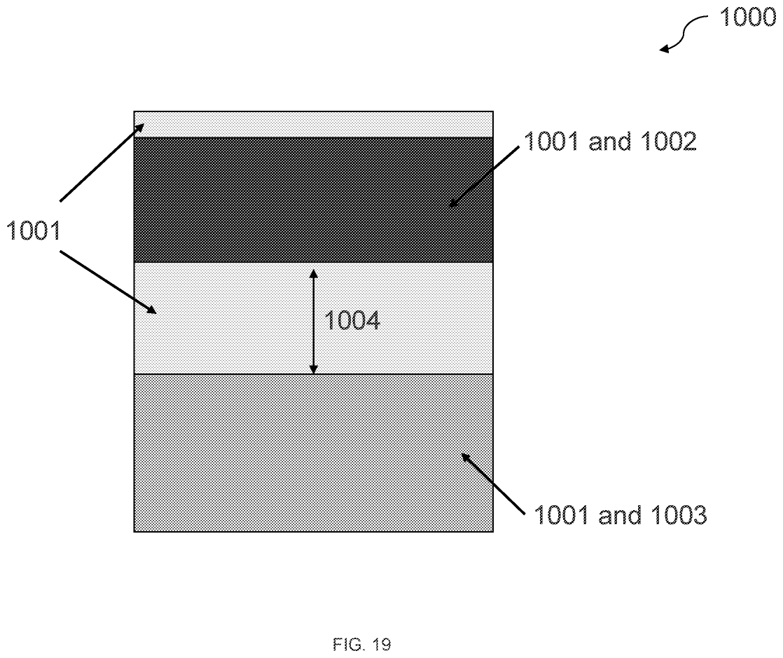

FIG. 19 shows the separate treatment locations on the sample-conjugate pad 1000 according to one embodiment described herein. The entire sample-conjugate pad 1000 may be treated with a single buffer composition 1001 that is compatible with various chemistries. A second buffer composition 1002 may be applied to a narrowed portion of the treated pad. In some cases, the second buffer may stabilize the test sample and detection method. A third buffer composition 1003 may be added to a different narrow portion of the treated pad. In some cases, the third buffer composition 1003 and second buffer composition 1002 may not be chemically compatible or the third buffer composition 1003 may not be compatible with the later stages of the detection method. In those cases, a separation zone 1004 may be used. The size of the separation zone 1004 may depend on the specific chemistries of the buffers used and/or the specific analyte being detected.

In some embodiments, each buffer composition is added to the respective region of the sample-conjugate pad as a solution, and the pad is dried before the next buffer composition is added. The pre-treated sample-conjugate pad is ready for use when each of the buffer compositions has been added and the pad is dry. The pad is treated with sufficient amount of buffer (i.e., a sufficient weight of dried buffer composition) that no additional buffers need to be added to a liquid sample prior to testing the sample using the detection layer and no buffer solution must be added to facilitate the test method.

In some cases, the buffers used may be highly concentrated within the treated pad. For example, in certain embodiments, the weight of the dry pad may increase about 20 to 40 mg/mL of pad after the first buffer treatment, which is a 40 to 80 percent increase in weight. The weight of the dry pad may increase an additional 5 to 13 mg/mL of pad after the second and third buffer treatments, for a total 50 to 106 percent increase in weight. One example of the weight change after the addition of buffers is shown in Table 1.

TABLE 1

| Pad | Length | Width | Thickness | Volume | Weight | Weight |
|---|---|---|---|---|---|---|
| condition | (mm) | (mm) | (mm) | (mL) | (mg) | Increase |
| Stock | 103.22 | 6 | 0.6 | 372 | 50 | 0% |
| After Buffer | 103.07 | 6 | 0.6 | 371 | 81 | 62% |
| 1 (full | | | | | | |
| coverage) | | | | | | |
| After Buffer | 101.81 | 6 | 0.6 | 367 | 92 | 84% |
| 2 and 3 | | | | | | |
| (zone | | | | | | |
| coverage) | | | | | | |

In some instances, the apparatus further comprises a sample pad capable of receiving the liquid, and in some cases, the liquid moves from the sample pad to the chromatographic membrane. In some embodiments, the liquid moves from the chromatographic membrane to a wick or absorbent pad. In some embodiments, the detection unit further comprises a conjugate pad. In some embodiments, the sample pad and conjugate pad may be connected. In other embodiments, the sample pad and conjugate pad may be combined. In some embodiments, at least a portion of the sample pad-conjugate pad overlaps the chromatographic membrane pad. In some embodiments, the sample pad-conjugate pad and the absorbent pad are not connected. In some embodiments, the absorbent pad can be separated from the chromatographic pad with an impermeable membrane, except for the area where the absorbent pad overlaps a portion of the chromatographic membrane pad.

In some embodiments, the detection unit can be configured to direct flow of a liquid through the detection unit in a generally horizontal orientation, e.g., substantially along a single horizontal plane from a first end of the detection unit to the second end of the detection unit. In other embodiments, the detection unit can be configured to direct flow of a liquid through the detection unit in a generally vertical orientation, e.g., substantially through a plurality of vertical planes, i.e., from the bottom of the detection unit to the top of the detection unit. In some embodiments, the detection unit can be configured to split the flow of a liquid through the detection unit into multiple paths. In some embodiments, the liquid may flow along from a first path to a second curved path that is substantially parallel to the first path. In some embodiments, this second path may flow counter-current to the direction of the first path.

In some embodiments, the configuration of the detection unit, specifically the relationship of the chromatographic membrane and the absorbent pad to each another may result in a flow path in a portion of the detection unit being counter-current or s-shaped in nature. In some examples, the flow of liquid in the absorbent pad is counter-current to the direction of flow in the chromatographic membrane pad. In some embodiments, the configuration of the detection unit may allow for the overall length of the detection unit to be substantially less than a conventional detection unit that maintains a single-direction flow path throughout the length of the detection unit. By overlapping the chromatographic membrane pad and the absorbent pad, the overall length of the detection unit can be significantly reduced without reducing the length of the overall flow path of the liquid. In some embodiments, the overall length of the detection unit may be further reduced by utilizing s-shaped flow paths in the detection unit.

In some embodiments, the absorbent pad may include a desiccant. For example, the absorbent pad may be impregnated with a desiccant such as silica gel. In some cases, the desiccant may aid in preventing absorption prior to use of the apparatus by the detection unit or conjugate pad, which may be sensitive to moisture. The desiccant may direct all the moisture to the desiccant. In some cases, the desiccant-impregnated absorbent pad may aid to increase the shelf-life of the apparatus. In some cases, the desiccant may be a separate pad that is removable from the apparatus. In other cases, the desiccant may be embedded within the housing. In certain embodiments, the desiccant may be a polymer-matrix with embedded molecular sieves. These molecular sieves may absorb VOCs and other potentially detrimental gasses and vapors. In some embodiments, the desiccant may include a color indicator to identify if the test has been compromised. In still other embodiments, the desiccant pad may also be used as an oxygen absorber.

In some embodiments, the signal that indicates presence or absence of a target compound may include any one of: an appearance of a colored dot or region, an absence of any appearance of a colored region, a completion of a pattern, a completion of a line, a completion of a logo, a completion of a symbol, a printing of a word, checkmark, emoticon, symbol, fluorescence, vibration, or sound. In some embodiments, the signal may be made by any one of: electrochemical detection, polymerization or de-polymerization in the presence of an analyte, endothermic reaction, exothermic reaction initiation, hydrogel formation, electronic device-aided quantitation, fluorescence, enzymatic reaction, or magnetic field fluctuation.

In some embodiments, the signal is displayed by a marker. The marker may include at least one of carboxyfluorescein, 2,7-dichlorofluorescein, Eosin B, Eosin Y, erythrosine, fluorescein, fluorescein amidite, fluorescein isocyanate, gold nanoparticles, aptamers, antibodies, merbromin, phloxine B, Rose Bengal, derivatives and salts thereof, or combinations thereof.

The detection unit described herein is disposed in a cavity of the housing. In some embodiments, the detection unit can be coupled to a housing or rod. For example, the detection unit may be coupled to the housing by heat sealing, ultrasonic welding, or adhesive, laser welding, heat staking, RF welding, inductive welding, mechanical fastening, solvent bonding, or adhesive bonding.

In some embodiments, the detection unit can be configured to minimize, significantly reduce, or substantially eliminate backflow or migration of an assay component into the test liquid. This backflow or potential flow of constituents from the detection unit to the test liquid may be undesirable, especially for testing of consumable liquids. In some embodiments, the potential backflow or reverse flow may comprise the test liquid and chemical additives from the detection unit. To address the potential for backflow, in some embodiments, the detection unit may further comprise a backflow reduction component. In some embodiments, the backflow reduction component may be an untreated pad between the sample entry port or opening in the protective layer and the sample pad. The untreated pad may minimize, significantly reduce, or substantially eliminate potential flow of material back to the test liquid due to saturation of the untreated pad upon introduction of the apparatus into the test liquid. Once introduced into the test liquid, the saturated untreated pad may serve as a constraint on backflow by minimizing the gradient and motive force of flow from the sample pad to the test liquid. In some embodiments, this constraint of flow by the saturated untreated pad may at least significantly reduce potential contact between chemical additives or buffers from the detection unit and the test liquid. In some embodiments, the constraint of flow by the saturated untreated pad may help ensure that essentially none of the chemical additives or buffers from the detection unit come in contact with the test liquid. In some embodiments, the design and configuration of the housing may sufficiently encase the detection unit to substantially prevent backflow to the test liquid. In this embodiment, the opening for liquid entry is small in comparison to the size and surface area of the apparatus. For example, when the apparatus is introduced to a liquid, the relatively small opening for liquid presents the only potential backflow path. The substantially small size of the opening reduces the potential for back flow. In some examples, the backflow reduction component can prevent at least about 70% of the assay components from migrating into the liquid sample, for example, at least about 75%, at least about 80%, at least about 85%, at least about 90%, at least about 95%, or at least about 99%.

In some embodiments, the apparatus comprises a boundary that may substantially prevent liquid entrainment at the boundary when the apparatus is fully submerged. In some examples, the boundary refers to the peripheral edge of the apparatus or the perimeter of two joined edges. In some embodiments, the apparatus comprises a boundary that can be configured to substantially prevent liquid entrainment at the boundary when the apparatus is fully submerged. The boundary configuration may be achieved by any one of adhesive, bond, weld, compressive force, mateable arrangements (stud/anti-stud), electrostatic interaction, and magnetic interaction or other methods. In such cases, the full submersion of the apparatus in a liquid may have no effect on the detection unit. In some embodiments, the opening for liquid entry is small in comparison to the size and surface area of the sealed apparatus. For example, when the apparatus is introduced to a liquid, the relatively small opening for liquid presents the only path to the detection unit. The substantially small size of the opening reduces the potential for flooding of the detection unit.

In some embodiments, the detection unit described herein is entirely contained within the housing described herein. Thus, in some embodiments, the detection unit must be very small. In some embodiments, the detection unit includes a thickness ranging from about 0.1 millimeters (mm) to about 10 mm. In some embodiments, the detection unit includes a thickness ranging from about 1 mm to about 5 mm. In some embodiments, the detection unit can have a thickness of about 0.4 mm or less, 0.5 or less, 1 mm or less, 2 mm or less, 3 mm or less, 4 mm or less, 5 mm or less, 6 mm or less, 7 mm or less, 8 mm or less, 9 mm or less, or 10 mm or less.

In some embodiments, the detection unit can have a length of about 10 mm to about 30 mm, or from about 10 mm to about 20 mm. In some embodiments, the detection unit can have a length of about 10 mm or less, 11 or less, 12 mm or less, 13 mm or less, 14 mm or less, 15 mm or less, 16 mm or less, 17 mm or less, 18 mm or less, 19 mm or less, 20 mm or less, 21 mm or less, 22 mm or less, 23 mm or less, 24 mm or less, 25 mm or less, 26 mm or less, 27 mm or less, 28 mm or less, 29 mm or less, or 30 mm or less.

In some embodiments, the detection unit includes up to about a width of about 20 mm or less, for example, a width of about 19 mm, a width of about 18 mm, a width of about 17 mm, a width of about 16 mm, about 15 mm, about 14 mm, about 13 mm, about 12 mm, about 11 mm, or about 10 mm. In some examples, the detection unit may have a width of about 10 mm to about 3 mm. In some embodiments, the detection unit includes up to about a width of about 6 mm, for example, a width of about 5 mm, about 4.5 mm, about 4 mm, about 3.5 mm, about 3 mm, or about 2.5 mm.

Some embodiments of the detection unit described herein can have a length of less than about 25 mm, a width of about 15 mm, and a thickness of about 5 mm. In some embodiments, the detection unit described herein can have a length of less than about 17 mm, a width of about 5 mm, and a thickness of about 1 mm. In some embodiments, the detection unit described herein can have a length of less than about 12 mm, a width of about 4 mm, and a thickness of about 1 mm.

A particular advantage of miniaturization of a lateral flow assay is timeliness of test results. For example, a conventional lateral flow assay with an 80 mm long chromatographic membrane requires a minimum of 5 minutes to display test results. In contrast, some embodiments of the miniaturized assays described herein display test results much faster. For example, a 12 mm detection unit comprising a buffer formulation as described herein requires only about 30 seconds to display test results. An additional advantage of a miniaturized lateral flow assay is reduced test fluid volume. In some examples, a sample volume of no more than 15 μL is required for an apparatus described herein, compared to 80 μL for a conventional 80 mm lateral flow assay. In some embodiments, sample volume is less than 40 μL, less than 30 μL, less than 20 μL, less than 10 μL, or less than 5 μL. In some embodiments test results are displayed in less than 1 minute, less than 30 seconds, less than 15 seconds, less than 10 seconds, or less than 5 seconds.

Any embodiment of a detection unit described herein may be used with any embodiment of a housing described herein, provided the detection unit fits inside the cavity of the housing, the entry port of the housing is aligned with a sample area of the detection unit, and the indication displayed by the detection unit is visible through the housing (e.g., through a transparent portion of the housing, through and opening, or through a window).

FIGS. 20-23 show examples of the detection unit, which may be used in any housing described herein.

FIG. 20 shows a top view of a detection unit 200 according to one embodiment described herein. The detection unit 200 comprises an absorbent pad 260 (sometimes referred to as a wick) and a test strip 280. The test strip 280 comprises sample pad-conjugate pad 250 and a chromatographic membrane pad 230. The sample pad-conjugate pad 250 contacts the proximal end of chromatographic membrane pad 232. The sample pad-conjugate pad 250 may be separated from the absorbent pad 260. Liquid absorbed into the sample-conjugate pad 250 may flow to a distal end of the chromatographic membrane pad 234 and then flow outwardly through absorbent pad 260. The distal end of the chromatographic membrane 234 overlaps a portion of the u-shaped absorbent pad 260.

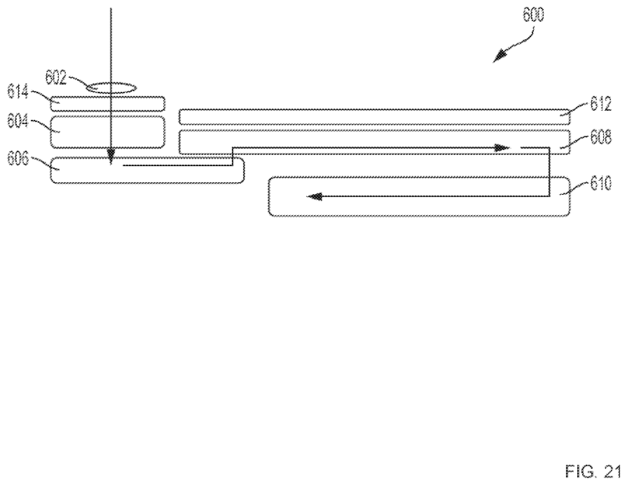

FIG. 21 shows a cross sectional view of the detection unit and the general direction of flow of a liquid medium through the detection unit 600. The liquid enters the detection unit through opening/sample port 602. The liquid flows from the opening to the sample pad 604, through the sample pad 604 to the conjugate pad 606, through the conjugate pad 606 to the chromatographic membrane pad 608, through the chromatographic membrane pad 608 to the absorbent pad 610, and finally diffuses within the absorbent pad 610. As shown in FIG. 21, the transitions to the subsequent pad in the flow path may be vertical, such as the flow from the conjugate pad 606 to the chromatographic membrane pad 608 and the chromatographic membrane pad 608 to the absorbent pad 610.

In FIG. 21, the configuration of the pads may also result in the flow path in a portion of the detection unit being in the opposite direction as compared to the flow on a previous or subsequent pad of the detection unit. For example, the liquid in the absorbent pad/wick 610 flows opposite to the direction of liquid flow in the chromatographic membrane pad 608. This configuration of the detection unit may allow for the overall length of the detection unit to be substantially less than a conventional detection unit that maintains a single flow path (i.e., a single flow direction) throughout the detection unit. This configuration allows for the overall length of the detection unit to be significantly reduced without reducing the overall flow path of the liquid. Thus, the configuration may achieve a detection unit in which the flow path of the liquid is longer than the overall length of the detection unit. In some examples, the length of the flow path may by two or three times the length of the detection unit. The optional untreated pad 614 may significantly reduce back flow through the opening 602 once the untreated pad 614 becomes fully saturated.

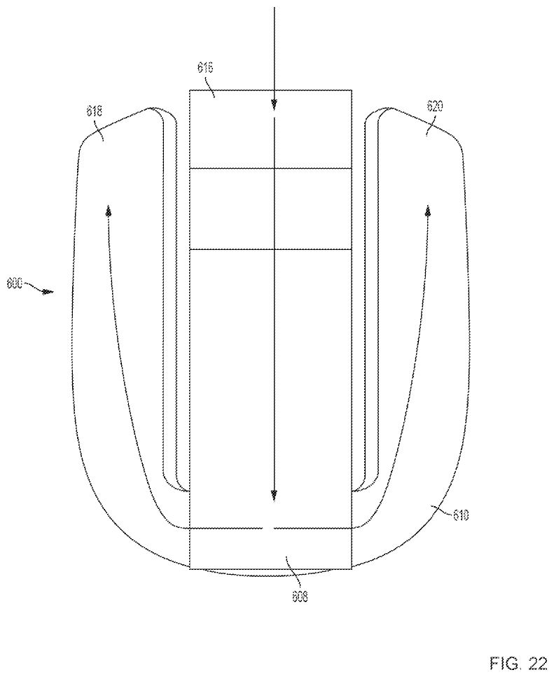

FIG. 22 shows the top view of the detection unit and the direction of flow of a liquid through the detection unit 600. The liquid enters the detection later and flows to the sample pad-conjugate pad 616, through the sample pad-conjugate pad 616 to the chromatographic membrane pad 608, through the chromatographic membrane pad 608 to the absorbent pad 610, and finally diffuses in the absorbent pad 610. As shown in FIG. 22, a flow path may be curved, such as the flow through the absorbent pad 610. Where the absorbent pad 610 is substantially U-shaped, the flow path of the liquid may be curved to substantially match the U-shaped of the absorbent pad 610. Furthermore, the flow direction of the liquid through the absorbent pad 610 may be counter-current to the flow direction of the liquid through the chromatographic membrane pad 608. In FIG. 22, the flow of liquid from the chromatographic membrane pad 608 splits when transitioning to the absorbent pad 610 with a portion of the liquid flowing to the proximal end of the absorbent pad 618 and a portion of the liquid flowing to the distal end of the absorbent pad 620.

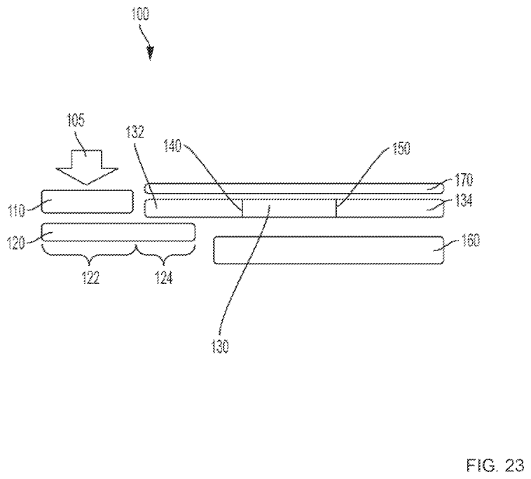

FIG. 23 is an exploded cross-section view of an apparatus 100 according to one embodiment described herein. Apparatus 100 comprises a sample pad 110, a conjugate pad 120, a detection unit 130 and an absorption pad or wick 160. The sample pad 110 is adjacent to a first portion 122 of the conjugate pad 120 so that in use a liquid is absorbed into the conjugate pad 120 from the sample pad 110. A second portion 124 of the conjugate pad is adjacent to the chromatographic membrane 130 at a proximal end 132 of the chromatographic membrane 130 so that in use a liquid is absorbed into the chromatographic membrane at the proximal end 132 and moves through the chromatographic membrane toward the distal end 134 of the chromatographic membrane 130. Between the proximal and distal ends the chromatographic membrane includes at least one test line 140 where an analyte-conjugated protein is deposited and at least one control line 150 where an anti-species antibody is deposited. The apparatus also comprises an absorption pad or wick 160 adjacent to the chromatographic membrane 130 so that in use liquid is absorbed into the wick from the chromatographic membrane 130. In some embodiments multiple test lines may be present to test for a plurality of targeted substances. Optionally, the apparatus may have a clear protective layer 170.

The design of the apparatus is not limited by the designs described in the Figures. The system may be produced by any technique known in the art.

In some embodiments, the detection unit comprises a thickness ranging from about 50 microns to about 1000 microns. In some embodiments, the detection unit comprises a thickness ranging from about 200 microns to about 400 microns. In some embodiments, the detection unit can have a thickness of about 100 microns or less, 200 microns or less, 400 microns or less, 600 microns or less, 800 microns or less, or 1000 microns or less.

In some embodiments, the detection unit can be subject to different surface treatments. For example, the detection unit can be subject to a ozonation treatment. In some embodiments, the detection unit can be subject to one or more surface treatments that can increase the hydrophilicity of the layer, and can in some cases, improve wetting properties of the layer. In some embodiments, the detection unit can be subject to one or more surface treatments that can increase the hydrophobicity of the layer, and can in some cases, reduce wetting properties of the layer. In some embodiments, the surface treatment can aid in preventing air pockets or bubbles from forming at an opening when the apparatus is exposed to a liquid.

In some embodiments, the detection unit can be configured to detect the presence of a plurality of targeted substances. For example, the detection unit can be configured to detect multiple illicit drugs on one particular detection unit. In some embodiments, the detection unit can be physically divided to permit the detecting of multiple drugs without the inferring with the detection of another drug. As another example, a detection unit can be multiplexed with certain components to test for multiple drugs on a single detection unit. In some cases, the detection unit that can run multiple tests in series. In some embodiments, the apparatus can include a plurality of discrete, physical sections positioned adjacent to each other to make up a single detection unit. For example, a plurality of matrices can be positioned side by side with each matrix configured to test for the presence of a different compound in a liquid.

In some embodiments, the apparatus comprising a detection unit can also include at least one additional layer. In some embodiments, the apparatus can include at least one of a top layer, a bottom layer, and a removable layer. In some embodiments, the apparatus can include any combination of layers described herein. In some cases, the removable layer may provide a hermetic seal and provide a moisture barrier for the detection unit.

The apparatus described herein can also include a top layer positioned on a top surface of a detection unit. In some embodiments, the top layer can be coupled to the detection unit using an adhesive. In some embodiments, the adhesive can comprise acrylate copolymer microspheres, acrylic and methacrylic ester homo-or copolymers, butyl rubber based systems, silicones, urethanes, vinyl esters and amides, olefin copolymer materials, di-alkyl fumarates, natural or synthetic rubbers, and the like, including hot-melt adhesives.

Coupling as described herein may be direct or indirect. The layers may be coupled by adhesive bonding (e.g., an adhesive backing, solvent bonding, UV adhesive, self-curing adhesive, or epoxy), welding (e.g., ultrasonic welding, laser welding, or heat sealing), mechanical fastening (e.g., crimping, mateable surfaces (stud/anti-stud) or other mechanical fastening means), electrostatic interaction, magnetic interaction, otherwise covering a surface, or other methods known to those of skill in the art.

In other embodiments, the top layer can be coupled to the detection unit by heat sealing at least a portion of the respective layers, by ultrasonic welding the two layers, through the use of ultraviolet radiation curable adhesive, or through the use of pressure-sensitive adhesives. In some embodiments, other suitable binding material or methods known to those of skill in the art can be used to couple the detection unit to the top layer.

Optionally, the assay matrix (e.g., the sample-conjugate pad and/or other pads) can be pre-treated with a buffering agent. The buffering agent can be, for example, acetic acid and a conjugate base thereof, citric acid and a conjugate base thereof, dibasic sodium phosphate, polyelectrolyte polymers, potassium hydrogen phthalate, sodium hydroxide, sodium phosphate, and combinations thereof. The matrix can be pre-treated with a buffering agent such that the matrix may be buffered at a pH ranging from about 3 to about 8 (e.g., from about 4 to about 6 or from about 4.5 to about 5.5). For example, the buffering agent can be added to the composition to provide a pH of about 3, about 3.5, about 4, about 4.5, about 5, about 5.5, about 6, about 6.5, about 7, about 7.5, about 8, about 8.5, or about 9. Buffers that can used in the described apparatus can include, for example, those described and set forth in PCT/US2017/015489.

For example, a first buffer solution may be applied to a sample area to deposit buffering compounds and buffer additives selected to neutralize or counteract beverage components that might interfere with a test result. Another buffer solution may be applied to the chromatographic membrane to increase the viscosity of the beverage or liquid, for example to slow its migration across the chromatographic membrane. In some embodiments specific combinations of buffer solutions may be used in an apparatus where a first buffer solution is applied to the sample area, a second buffer solution is applied to the chromatographic membrane, and the first and second buffer solutions are different. Such combinations of buffer solutions can be used synergistically to improve the performance of the apparatus and methods across a wide range of test liquids.

In some embodiments, specific combinations of neutralizing agents, buffering agents, and surfactants are used synergistically to improve the performance of the assay across a wide range of sample matrices. Neutralizing agents can be used alone or in combination with buffering agents to improve assay performance across a diverse set of test liquids. Neutralizing reagents may include traditional buffering agents, such as Good's buffer salts, and other acidic or basic components which treat the sample prior to the sample encountering the detection means. Neutralizing reagents may consist of carboxylate salts such as sodium citrate or potassium carbonate. Buffering reagents create a stable and consistent environment for the detection means to function within and may consist of ionic or zwitterionic buffer salts. Alone buffering agents may not provide adequate neutralization of all sample types. Neutralizing agents alone may be too acidic or basic to be compatible with the detection means. For example, one potential combination of neutralizing agent and buffering agent is potassium carbonate (0.1 to 3M) and tris (0.1M to 3M), respectively, at any combination of neutralizing and buffering agent concentrations within the specified ranges. In some embodiments, the ratio of neutralizing agent to buffering agent is 2:1.

The neutralizing agent may be located in an assay component such as the sample pad or area which is separate from the buffering agent located in the conjugate pad or area. In some cases, the neutralizing agent is K₂CO3 (0.1 to 3M) or other carboxylate salt. In some cases, the buffering agent is Tris (0.1M to 3M) or other Good's buffer agent. Separation of the neutralizing agent from the conjugate pad is of particular importance when the neutralizing agent is not compatible with the antibody-particle conjugate as is the case with K₂CO₃ and antibody-gold nanoparticle conjugates. The neutralizing agent may deposited on the same assay component but in a separate area from the detection means. In some cases, the neutralizing agent is K₂CO₃ (0.1 to 3M) or other carboxylate salt. In some cases, the buffering agent is Tris (0.1M to 3M) or other Good's buffer agent.

In some embodiments, certain combinations of non-ionic surfactants are particularly useful for ensuring an apparatus described herein is compatible with a wide range of test liquids. These non-ionic surfactants may be used alone or in conjugation with neutralizing and buffering agents. In some examples, a first non-ionic surfactant is Pluronic F68 (0.1% to 2%) or other poloxamer and a second non-ionic surfactant is Triton X-100 (0.1% to 2%) or other polyethylene oxide phenyl ether at any combination of concentrations within the stated ranges for each compound. Buffer formulations and residual buffer formulation may comprise a first and a second non-ionic surfactant at any combination of concentrations within the stated ranges for each surfactant. The non-ionic surfactants may be located in the conjugate pad. The non-ionic surfactants may be located in the sample pad. One non-ionic surfactant may be located in the sample pad and one non-ionic surfactant may be located in the conjugate pad.

In some embodiments, combinations of neutralizing agents, buffering agents, and non-ionic surfactants were found to improve assay performance. For example, a useful combination includes the neutralizing agent K₂CO₃ (0.1 to 3M), buffering agent Tris (0.1M to 3M), the non-ionic surfactant Triton X-100 (0.1 to 2%), and a second non-ionic surfactant Pluronic F68. In some examples, an apparatus described herein includes a specific combination of residual buffer formulations that can render the apparatus compatible with a wide range of test fluids. For example, a first residual buffer formulation may be used at a location near the beginning of the liquid flow path, for example the sample area, to interact with components in the test fluid that could be detrimental to test results, such as acids, alcohol, and/or colorants, and a second residual buffer formulation may be used at a separate location further down the liquid flow path to buffer the test liquid near a certain pH so as not to denature proteins involved in the assay.

In addition, a specific combination of buffer formulations can allow combining multiple detection means (such as using two or more marker-test line combinations) for detecting multiple analytes, whereas in the absence of the specific combination of residual buffer formulations the different detection means would not be compatible with the same scope of test fluids. In one example, in the absence of a particular residual buffer formulation, a first detection means for detecting a first analyte is only compatible with test fluids A and B, and a second detection means for detecting a second analyte is only compatible with test fluids B and C. In that case, the first and second means could not be used in combination to simultaneously detect the first and second analytes in fluids A and C. But a single apparatus including an appropriate combination of residual buffer formulations is compatible with fluids A, B, and C, and can detect the first and the second analytes in all three fluids. This “multiplexing” is useful for the detection of multiple analytes with may require different detection means (such as different antibodies, aptamers, or markers) with a single apparatus. In some examples, an apparatus described herein may detect the presence of both benzodiazepines and ketamines.

### Method of Making an Adaptable Apparatus

In other embodiments, a method of making an adaptable apparatus is described herein. In some embodiments, the method of making an adaptable apparatus includes providing a housing including a cavity and a structure capable of being attached to a drink container or an implement; placing a detection unit in the cavity, where the detection unit is configured to detect the presence of a target substance; optionally coupling the detection unit to the housing; and coupling a protective layer over the detection unit and to the housing and/or to the detection unit. In some embodiments, the method of making also includes coupling a removable layer to the protective layer. In some embodiments, the method of making also includes coupling a removable layer to the housing. In some embodiments, the strength of the coupling of the removable layer to the housing or protective layer may be less than the strength of the coupling of the protective layer to the detection unit. In some cases, the apparatus may be coupled to an implement.

Coupling as described herein may be direct or indirect. The layers may be coupled by adhesive bonding (e.g., an adhesive backing, solvent bonding, UV adhesive, self-curing adhesive, or epoxy), welding (e.g., ultrasonic welding, laser welding, or heat sealing), mechanical fastening (e.g., crimping, or mateable surfaces (stud/anti-stud)), electrostatic interaction, magnetic interaction, otherwise covering a surface, or other methods known to those of skill in the art.

### Method of Using an Adaptable Apparatus

In yet further embodiments, a method of using an apparatus to detect a target substance is described herein. In some embodiments, the method of using includes providing an apparatus described herein, exposing a portion of the apparatus to a medium, and observing an indication to determine the presence or absence of the target substance. In some embodiments, the method of using includes removing a removable layer from the apparatus to expose at least a portion of the detection unit. In some embodiments, the method of using includes observing a visual indication.

In some embodiments, the method of using includes exposing an apparatus to a liquid medium. In some embodiments, exposing the apparatus to the liquid medium includes contacting the medium with the apparatus. In other embodiments, exposing a portion of the apparatus to the medium includes collecting a sample of the medium on an implement and using the implement to contact the sample to the apparatus. In some embodiments, the method of using can be exposed to a medium comprising at least one of beer, cider, energy drinks, flavored drinks, fruit drinks, liquor or other alcoholic beverages, milk, milk-containing beverages, potable water, soda, sports drinks, vegetable drinks, water, wine, and combinations thereof. In some embodiments, the medium can include at least one of non-consumable liquid (e.g., blood, non-potable water, organic solvents, serum, treated waste water, untreated waste water, urine, vomit, sweat, tears, feces, reproductive fluids, other bodily secretions, or combinations thereof). In some embodiments, the target substance may include any one of illicit drugs, amine-containing compounds, benzodiazepines, analytes, narcotics, alcohol, date rape drugs.

### Illustrative Embodiments of Suitable Methods, Products, and Systems.

As used below, any reference to methods, products, or systems is understood as a reference to each of those methods, products, or systems disjunctively (e.g., “Illustrative embodiment 1-4 is understood as illustrative embodiment 1, 2, 3, or 4.”).

Illustrative embodiment 1 is an apparatus for detecting the presence of a targeted substance in a liquid, the apparatus comprising: a housing comprising a cavity:
a detection unit for receiving a liquid, wherein the detection unit is disposed in the cavity, and wherein the detection unit is capable of displaying an indication that a targeted substance is present or absent; and
a protective layer disposed over the detection unit and coupled to the detection unit or to the housing, wherein the protective layer comprises an opening over a portion of the detection unit, and wherein the housing limits a volume and a flowrate of a fluid that can reach the detection unit.

Illustrative embodiment 2 is the apparatus of any preceding or subsequent illustrative embodiment, wherein the opening is an entry port through which a fluid external to the housing can enter the cavity and contact the detection unit.

Illustrative embodiment 3 is the apparatus of any preceding or subsequent illustrative embodiment, further comprising a removable layer disposed over at least a portion of the protective layer configured such that upon removal of the removable layer, at least a portion of the detection unit is exposed to an external environment.

Illustrative embodiment 4 is the apparatus of any preceding or subsequent illustrative embodiment, further comprising an opening in the housing to provide a vent for a gas within the apparatus.

Illustrative embodiment 5 is the apparatus of any preceding or subsequent illustrative embodiment, wherein the detection unit is a lateral flow assay.

Illustrative embodiment 6 is the apparatus of any preceding or subsequent illustrative embodiment, wherein the detection unit comprises a sample pad, a conjugate pad, a chromatographic membrane pad, and an absorbent pad,
wherein the sample pad is configured to transfer the liquid to the conjugate pad;
wherein the conjugate pad is configured to transfer the liquid to the chromatographic membrane pad;
wherein the chromatographic membrane pad comprises a marker, overlaps a portion of the sample pad, and is configured to transfer the liquid to the absorbent pad;
wherein the absorbent pad overlaps a portion of the chromatographic membrane pad, and is configured to draw the liquid from the chromatographic membrane pad;
wherein the marker is configured to display a signal upon a detection of the target sub stance;
wherein the signal is a visual indication that the target substance is present or absent.

Illustrative embodiment 7 is the apparatus of any preceding or subsequent illustrative embodiment, wherein the signal comprises any one of: an appearance of a colored dot or region, an absence of any appearance of a colored region, a completion of a pattern, a completion of a line, a completion of a logo, a completion of a symbol, a printing of a word, checkmark, emoticon, symbol, fluorescence, vibration, or sound.

Illustrative embodiment 8 is the apparatus of any preceding or subsequent illustrative embodiment, wherein the signal is made by any one of: electrochemical detection, polymerization or de-polymerization in the presence of an analyte, endothermic reaction, exothermic reaction initiation, hydrogel formation, electronic device-aided quantitation, fluorescence, enzymatic reaction, or magnetic field fluctuation.

Illustrative embodiment 9 is the apparatus of any preceding or subsequent illustrative embodiment, wherein the marker comprises at least one of carboxyfluorescein, 2,7-dichlorofluorescein, Eosin B, Eosin Y, erythrosine, fluorescein, fluorescein amidite, fluorescein isocyanate, gold nanoparticles, aptamers, antibodies, merbromin, phloxine B, Rose Bengal, derivatives and salts thereof, or combinations thereof.

Illustrative embodiment 10 is the apparatus of any preceding or subsequent illustrative embodiment, wherein the target substance comprises any one of: amine-containing compound, benzodiazepine, narcotic, alcohol, date rape drug, pesticide, steroid, steroid metabolite, bacteria, pathogen, fungus, poison, toxin, explosive, explosive precursor material, metal, protein, and sugars.

Illustrative embodiment 11 is the apparatus of any preceding or subsequent illustrative embodiment, wherein the liquid comprises any one of: beer, cider, energy drink, flavored drink, fruit drink, liquor, alcoholic beverage, milk, milk-containing beverage, soda, sports drink, vegetable drink, water, wine, blood, non-potable water, organic solvent, potable water, serum, treated waste water, untreated waste water, urine, sweat, vomit, and combinations thereof.

Illustrative embodiment 12 is the apparatus of any preceding or subsequent illustrative embodiment, wherein the housing comprises a polymeric material comprising at least one of acrylonitrile butadiene styrene, acrylonitrile butadiene styrene and polycarbonate alloy, acetal polyoxymethylene, liquid crystal polymer, nylon 6-polyamide, nylon 6/6-polyamide, nylon 11-polyamide, polybutylene terepthalate polyester, polycarbonate, polyetherimid, polyethylene, low density polyethylene, high density polyethylene, polyethylene terepthalate polyester, polypropylene, polyphthalamide, polyphenylene sulfide, polystyrene crystal, high impact polystyrene, polysulfone, polyvinylchloride, polyvinylidene fluoride, styrene acrylonitrile, thermoplastic elastomer, thermoplastic polyurethane elastomer, cyclic olefin copolymer, and styrene butadiene copolymer.

Illustrative embodiment 13 is the apparatus of any preceding or subsequent illustrative embodiment, wherein the housing further comprises:
first and second opposing faces separated by a thickness, wherein the first and second opposing faces are substantially planar, and wherein the first opposing face comprises the cavity; and
a peripheral surface connecting the first and second opposing faces and extending around a periphery of the housing.

Illustrative embodiment 14 is the apparatus of any preceding or subsequent illustrative embodiment, wherein the periphery of the housing is substantially circular.

Illustrative embodiment 15 is the apparatus of any preceding or subsequent illustrative embodiment, wherein the housing further comprises a passageway from a first opening in the peripheral surface through at least a portion of the housing.

Illustrative embodiment 16 is the apparatus of any preceding or subsequent illustrative embodiment, wherein the passageway ends at a second opening in the peripheral surface.

Illustrative embodiment 17 is the apparatus of any preceding or subsequent illustrative embodiment, wherein the apparatus is capable of being removably attached to a liquid vessel or one or more implements.

Illustrative embodiment 18 is the apparatus of any preceding or subsequent illustrative embodiment, wherein the implements comprise at least one of a drinking straw, a drink stirrer, an adaptor, a hook, a rod, a key ring, a lanyard, tool, or a clip.

Illustrative embodiment 19 is the apparatus of any preceding or subsequent illustrative embodiment, wherein the housing is a rod.

Illustrative embodiment 20 is the apparatus of any preceding or subsequent illustrative embodiment, further comprising a submersible head connected to the rod.

Illustrative embodiment 21 is the apparatus of any preceding or subsequent illustrative embodiment, wherein the head comprises passageway so that the head is moveable along the length of the rod.

Illustrative embodiment 22 is the apparatus of any preceding or subsequent illustrative embodiment, wherein the device is configured to be positioned in a vessel comprising a liquid and is functional after submersion.

Illustrative embodiment 23 is a method of using an apparatus to detect the presence of a target substance in a liquid medium, said method comprising:
providing the apparatus of any preceding or subsequent illustrative embodiment;
exposing a portion of the apparatus to the liquid medium; and
observing an indication to determine presence or absence of the target substance.

Illustrative embodiment 24 is the method of any preceding or subsequent illustrative embodiment, wherein the target substance comprises any one of: amine-containing compound, benzodiazepine, narcotic, alcohol, date rape drug, pesticide, steroid, steroid metabolite, bacteria, pathogen, fungus, poison, toxin, explosive, explosive precursor material, metal, protein, and sugars.

Illustrative embodiment 25 is the method of any preceding or subsequent illustrative embodiment, wherein the liquid comprises any one of: beer, cider, energy drink, flavored drink, fruit drink, liquor, alcoholic beverage, milk, milk-containing beverage, soda, sports drink, vegetable drink, water, wine, blood, non-potable water, organic solvent, potable water, serum, treated waste water, untreated waste water, urine, vomit, sweat, tears, and combinations thereof.

Illustrative embodiment 26 is a method of making an apparatus to detect the presence of a target substance in a liquid medium, said method comprising:
providing a detection unit configured to detect the presence of a target substance;
coupling the detection unit to a housing, wherein the housing is capable of being attached to an implement; and
coupling a protective layer over the detection unit.

Illustrative embodiment 27 is the method of any preceding or subsequent illustrative embodiment, further comprising coupling a removable layer to the housing.

Illustrative embodiment 28 is the method of any preceding or subsequent illustrative embodiment, further comprising coupling the apparatus to an implement.

Embodiments of an apparatus are illustrated in the figures. As will be understood, the illustrated embodiments are provided as a way to illustrate the features and advantages of the present invention and should not be read as limiting the present invention to any particular examples. Further, the use of top, bottom and side in the following description of the figures is to aid understanding and should not be read as a geographic/orientation limitation of embodiments of the present invention.

The apparatus and methods of the appended claims are not limited in scope by the specific apparatus and methods described herein, which are intended as illustrations of a few aspects of the claims and any apparatus, systems, and methods that are functionally equivalent are intended to fall within the scope of the claims. Various modifications of the apparatus and methods in addition to those shown and described herein are intended to fall within the scope of the appended claims. Further, while only certain representative apparatus and method steps disclosed herein are specifically described, other combinations of the apparatus and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed.

1. An apparatus for detecting the presence of a targeted substance in a liquid, the apparatus comprising:
a housing comprising;
a cavity;
a detection unit for receiving a liquid, wherein the detection unit is disposed in the cavity, and wherein the detection unit is capable of displaying an indication that a targeted substance is present or absent; and
a protective layer disposed over the detection unit and coupled to the detection unit or to the housing, wherein the protective layer comprises an opening over a portion of the detection unit, and
wherein the housing limits a volume and a flowrate of a fluid that can reach the detection unit.

2. The apparatus of claim 1, wherein the opening is an entry port through which a fluid external to the housing can enter the cavity and contact the detection unit.

3. The apparatus of claim 1, further comprising a removable layer disposed over at least a portion of the protective layer configured such that upon removal of the removable layer, at least a portion of the detection unit is exposed to an external environment.

4. The adaptable apparatus of claim 1, further comprising an opening in the housing to provide a vent for a gas within the apparatus.

5. The apparatus of claim 1, wherein the detection unit is a lateral flow assay.

6. The apparatus of claim 1, wherein the detection unit comprises a sample pad, a conjugate pad, a chromatographic membrane pad, and an absorbent pad,
wherein the sample pad is configured to transfer the liquid to the conjugate pad;
wherein the conjugate pad is configured to transfer the liquid to the chromatographic membrane pad;
wherein the chromatographic membrane pad comprises a marker, overlaps a portion of the sample pad, and is configured to transfer the liquid to the absorbent pad;
wherein the absorbent pad overlaps a portion of the chromatographic membrane pad, and is configured to draw the liquid from the chromatographic membrane pad;
wherein the marker is configured to display a signal upon a detection of the targeted substance;
wherein the signal is a visual indication that the targeted substance is present or absent.

7. The apparatus of claim 6, wherein the signal comprises any one of: an appearance of a colored dot or region, an absence of any appearance of a colored region, a completion of a pattern, a completion of a line, a completion of a logo, a completion of a symbol, a printing of a word, checkmark, emoticon, symbol, fluorescence, vibration, or sound.

8. The apparatus of claim 6, wherein the signal is made by any one of: electrochemical detection, polymerization or de-polymerization in the presence of an analyte, endothermic reaction, exothermic reaction initiation, hydrogel formation, electronic device-aided quantitation, fluorescence, enzymatic reaction, or magnetic field fluctuation.

9. The adaptable apparatus of claim 6, wherein the marker comprises at least one of carboxyfluorescein, 2,7-dichlorofluorescein, Eosin B, Eosin Y, erythrosine, fluorescein, fluorescein amidite, fluorescein isocyanate, gold nanoparticles, aptamers, antibodies, merbromin, phloxine B, Rose Bengal, derivatives and salts thereof, or combinations thereof.

10. The apparatus of claim 1, wherein the targeted substance comprises any one of: amine-containing compound, benzodiazepine, narcotic, alcohol, date rape drug, pesticide, steroid, steroid metabolite, bacteria, pathogen, fungus, poison, toxin, explosive, explosive precursor material, metal, protein, and sugars.

11. The apparatus of claim 1, wherein the liquid comprises any one of: beer, cider, energy drink, flavored drink, fruit drink, liquor, alcoholic beverage, milk, milk-containing beverage, soda, sports drink, vegetable drink, water, wine, blood, non-potable water, organic solvent, potable water, serum, treated waste water, untreated waste water, urine, sweat, vomit, and combinations thereof.

12. The apparatus of claim 1, wherein the housing comprises a polymeric material comprising at least one of acrylonitrile butadiene styrene, acrylonitrile butadiene styrene and polycarbonate alloy, acetal polyoxymethylene, liquid crystal polymer, nylon 6-polyamide, nylon 6/6-polyamide, nylon 11-polyamide, polybutylene terepthalate polyester, polycarbonate, polyetherimid, polyethylene, low density polyethylene, high density polyethylene, polyethylene terepthalate polyester, polypropylene, polyphthalamide, polyphenylene sulfide, polystyrene crystal, high impact polystyrene, polysulfone, polyvinylchloride, polyvinylidene fluoride, styrene acrylonitrile, thermoplastic elastomer, thermoplastic polyurethane elastomer, cyclic olefin copolymer, and styrene butadiene copolymer.

13. The apparatus of claim 1, wherein the housing further comprises:
first and second opposing faces separated by a thickness, wherein the first and second opposing faces are substantially planar, and wherein the first opposing face comprises the cavity; and
a peripheral surface connecting the first and second opposing faces and extending around a periphery of the housing.

14. The apparatus of claim 13, wherein the periphery of the housing is substantially circular.

15. The apparatus of claim 13, wherein the housing further comprises a passageway from a first opening in the peripheral surface through at least a portion of the housing.

16. The apparatus of claim 15, wherein the passageway ends at a second opening in the peripheral surface.

17. The apparatus of claim 13, wherein the apparatus is capable of being removably attached to a liquid vessel or one or more implements.

18. The apparatus of claim 17, wherein the one or more implements comprise at least one of a drinking straw, a drink stirrer, an adaptor, a hook, a rod, a key ring, a lanyard, tool, or a clip.

19. The apparatus of claim 1, wherein the housing comprises a rod.

20. The apparatus of claim 19, wherein the housing further comprises a submersible head connected to the rod.

21. The apparatus of claim 20, wherein the head comprises a passageway so that the head is moveable along the length of the rod.

22. The apparatus of claim 19, wherein the device is configured to be positioned in a vessel comprising a liquid and is functional after submersion.

23. A method of using an apparatus to detect the presence of a targeted substance in a liquid medium, said method comprising:
providing the apparatus of claim 1;
contacting a portion of the apparatus with the liquid medium; and
observing an indication to determine presence or absence of the targeted substance.

24. The method of claim 23, wherein the targeted substance comprises any one of: amine-containing compound, benzodiazepine, narcotic, alcohol, date rape drug, pesticide, steroid, steroid metabolite, bacteria, pathogen, fungus, poison, toxin, explosive, explosive precursor material, metal, protein, and sugars.

25. The method of any claim 23, wherein the liquid comprises any one of: beer, cider, energy drink, flavored drink, fruit drink, liquor, alcoholic beverage, milk, milk-containing beverage, soda, sports drink, vegetable drink, water, wine, blood, non-potable water, organic solvent, potable water, serum, treated waste water, untreated waste water, urine, vomit, sweat, tears, and combinations thereof.

26. A method of making an apparatus to detect the presence of a targeted substance in a liquid medium, said method comprising:
providing a detection unit configured to detect the presence of a targeted substance;
coupling the detection unit to a housing, wherein the housing is capable of being attached to an implement; and
coupling a protective layer over the detection unit.

27. The method of claim 26, further comprising coupling a removable layer to the housing.

28. The method of claim 26, further comprising coupling the apparatus to an implement.
